(19) United States
(12) Patent Application Publication
(10) Pub. No.: US 2016/0052317 A1
(43) Pub. Date: Feb. 25, 2016

(54) DOUBLE-SIDED PRINTING METHOD AND APPARATUS

(71) Applicant: FUJIFILM Corporation, Tokyo (JP)

(72) Inventor: Tadashi KYOSO, Ashigarakami-gun (JP)

(73) Assignee: FUJIFILM CORPORATION, Tokyo (JP)

(21) Appl. No.: 14/718,928

(22) Filed: May 21, 2015

(30) Foreign Application Priority Data
Aug. 19, 2014 (JP) 2014-166451

(51) Int. Cl. B41J 29/393

(52) U.S. Cl. CPC B41J 29/393

(57) ABSTRACT

A gripping region is set at each of first and second ends of paper that is a medium. A region of a first surface excluding the gripping region is set as a first surface printable region. A first image printing region for printing a first image and a first test image printing region for printing a first test image are set in the first surface printable region. A region of a second surface excluding the gripping region is set as a second surface printable region. A second image printing region for printing a second image and a second test image printing region for printing a second test image are set in the second surface printable region. The first and second test image printing regions are set in the same region of the first and second surfaces.

### CROSS-REFERENCE TO RELATED APPLICATIONS

The present application claims priority under 35 U.S.C. §119 to Japanese Patent Application No. 2014-166451, filed on Aug. 19, 2014. The above application is hereby expressly incorporated by reference, in its entirety, into the present application.

### BACKGROUND OF THE INVENTION

1. Field of the Invention

The present invention relates to a double-sided printing method and apparatus, and in particular, to a double-sided printing method and apparatus to print not only a print target image but also a test image for checking the state of the apparatus.

2. Description of the Related Art

In a printing apparatus, the apparatus state is checked based on the print result. Typically, the state checking is performed by printing a test image, reading the print result with a scanner, and analyzing the read image data. For example, in an ink jet printing apparatus, a test image is printed, and the presence or absence of abnormalities, such as non-discharge, discharge direction failure, and a change in the amount of discharge, is checked from the print result.

Such checking is also performed during the execution of a print job. In the case of checking the state during the execution of a print job, a test image is printed in the marginal region of a medium (recording target) (for example, refer to JP1999-254793A (JP-H11-254793A) and JP2014-004736A). Accordingly, in the case of checking the state during the execution of a print job, it is necessary to secure a certain marginal region. The marginal region, that is, a region for printing the test image, is usually set in the front end portion or rear end portion of the medium in the printing direction.

### SUMMARY OF THE INVENTION

Incidentally, printing forms include a single-sided printing form, in which printing is performed on only one surface of the medium, and a double-sided printing form, in which printing is performed on both surfaces of the medium. Apparatus checking is also performed in the case of double-sided printing. In this case, a test image is printed on both surfaces of the medium.

Since a portion in which the test image is printed is an originally unnecessary portion, the portion in which the test image is printed is cut finally. Therefore, in the case of double-sided printing, a print target image cannot be printed in a portion on the back side corresponding to the portion in which the test image is printed.

In the related art, as a position where the test image is printed, that is, as a position of the marginal region for printing the test image, a fixed position of the medium with respect to the printing direction of the medium has been determined regardless of the front and back surfaces of the medium. For this reason, in the case of double-sided printing, a printable region (so-called client region) of an image to be printed has been greatly reduced. That is, in order to perform double-sided printing, it is necessary to reverse the front and back surfaces of the medium. However, there is a disadvantage in that the test image is printed on both the front and rear ends of the medium if the medium is reversed by reversing the front and rear sides of the medium and that the printable region is greatly reduced if an image is printed on the front and back surfaces of the medium in order to avoid the situation where the test image is printed on both the front and rear ends of the medium.

The invention has been made in view of such a situation, and it is an object of the invention to provide a double-sided printing method and apparatus capable of securing a wide printable region for an image to be printed even when printing a test image on both sides of the medium.

Means for solving the aforementioned problem is as follows.

According to a first of the invention, there is provided a double-sided printing method, including, when one surface of a medium is a first surface and the other surface of the medium is a second surface, an end of the first surface on a front side from the first surface in a printing direction of the first surface is a first end of the medium, and an end of the first surface on a rear side from the first surface in the printing direction is a second end of the medium, a first surface printing step of transporting the medium along a first transport path by gripping the first end and printing a first image and a first test image in a single pass on the first surface of the medium using a first printing unit provided on the first transport path, and a second surface printing step of transporting the medium along a second transport path by gripping the second end after the first surface printing step and printing a second image and a second test image in a single pass on the second surface of the medium using a second printing unit provided on the second transport path, in which a gripping region is set at each of the first and second ends of the medium, a region of the first surface excluding the gripping region is set as a first surface printable region, and a first image printing region for printing the first image and a first test image printing region for printing the first test image are set in the first surface printable region, a region of the second surface excluding the gripping region is set as a second surface printable region, and a second image printing region for printing the second image and a second test image printing region for printing the second test image are set in the second surface printable region, and the first and second test image printing regions are set in the same region of the first and second surfaces.

According to this aspect of the invention, the medium is transported along the first transport path in a state where the first end is gripped, and the first image and the first test image are printed in a single pass (one pass) on the first surface by the first printing unit provided on the first transport path (first surface printing step). Then, the medium is transported along the second transport path in a state where the second end is gripped, and the second image and the second test image are printed in a single pass on the second surface by the second printing unit provided on the second transport path (second surface printing step).

The layout of the image printed on each surface of the medium is set as follows. First, a gripping region is set at each of the first and second ends of the medium. The gripping region is a region for gripping the medium during transport. A region of the first surface excluding the gripping region is set as a first surface printable region, and a first image printing region for printing the first image and a first test image printing region for printing the first test image are set in the first surface printable region. A region of the second surface excluding the gripping region is set as a second surface printable region, and a second image printing region for printing the second image and a second test image printing region for printing the second test image are set in the second surface printable region. In this case, the first and second test image printing regions are set in the same region of the first and second surfaces. That is, the second test image printing region is set directly behind the first test image printing region. In other words, the first and second test image printing regions are set at positions overlapping each other when the medium is seen therethrough from one surface side of the medium. Therefore, even when printing a test image on both sides of the medium, it is possible to secure wide printable regions for the first and second images to be printed, that is, the wide first and second image printing regions. In addition, since the first and second test image printing regions are set in the same region of the first and second surfaces, the setting order is not particularly limited.

According to a second aspect of the invention, there is provided, a double-sided printing method, including, when one surface of a medium is a first surface and the other surface of the medium is a second surface, an end of the first surface on a front side from the first surface in a printing direction of the first surface is a first end of the medium, and an end of the first surface on a rear side from the first surface in the printing direction is a second end of the medium, a first surface printing step of transporting the medium along a transport path by gripping the first end and printing a first image and a first test image in a single pass on the first surface of the medium using a printing unit provided on the transport path, and a second surface printing step of transporting the medium along the transport path by gripping the second end after the first surface printing step and printing a second image and a second test image in a single pass on the second surface of the medium using the printing unit provided on the transport path, in which a gripping region is set at each of the first and second ends of the medium, a region of the first surface excluding the gripping region is set as a first surface printable region, and a first image printing region for printing the first image and a first test image printing region for printing the first test image are set in the first surface printable region, a region of the second surface excluding the gripping region is set as a second surface printable region, and a second image printing region for printing the second image and a second test image printing region for printing the second test image are set in the second surface printable region, and the first and second test image printing regions are set in the same region of the first and second surfaces.

According to this aspect of the invention, the medium is transported along the transport path in a state where the first end is gripped, and the first image and the first test image are printed on the first surface by the printing unit provided on the transport path (first surface printing step). Then, the medium is transported along the transport path in a state where the second end is gripped, and the second image and the second test image are printed on the second surface by the printing unit (second surface printing step). In addition, the method of determining the layout of the image printed on each surface of medium is the same as described in the first aspect of the invention. Therefore, even when printing a test image on both sides of the medium, it is possible to secure wide printable regions for images to be printed (first and second images), that is, the wide first and second image printing regions.

According to a third aspect of the invention, in the double-sided printing method according to the first aspect or the second aspect of the invention, a deformed region of the medium in case of transporting the medium by gripping the first end is set as a gripping region of the first end, and a deformed region of the medium in case of transporting the medium by gripping the second end is set as a gripping region of the second end.

According to this aspect of the invention, the gripping region is set in consideration of the deformation (grip marks, wrinkles, or the like) of the medium at the time of gripping. Therefore, since it is possible to prevent the deformation of the first and second test images, it is possible to prevent a reduction in the reading accuracy.

According to a fourth aspect of the invention, in the double-sided printing method according to any one of the first to third aspects of the invention, the first test image printing region is set at an end of the first surface printable region on the first end side or on the second end side.

According to this aspect of the invention, the first test image printing region is set at the end of the first surface printable region on the first end side or on the second end side. Therefore, the first and second test images can be cut together with the gripping region.

According to a fifth aspect of the invention, in the double-sided printing method according to any one of the first to fourth aspects of the invention, in case of printing the first and second images using ink of a plurality of colors, colors of ink to print the first test image and colors of ink to print the second test image are set so as to be switched for each medium, and the colors of ink to print the first test image and the colors of ink to print the second test image are set to different colors on the same medium.

According to this aspect of the invention, in case of printing the first and second images using the ink of a plurality of colors, the colors of ink to print the first test image and the colors of ink to print the second test image are switched for each medium. In addition, the colors of ink to print the first test image and the colors of ink to print the second test image are set to different colors on the same medium. For example, in case of printing the first and second images using the ink of four colors of cyan, magenta, yellow, and black, the first test image is printed by periodically switching the colors in order of cyan, magenta, yellow, and black, and the second test image is printed by periodically switching the colors in order of black, cyan, magenta, and yellow. Therefore, the colors of ink to print the first test image and the colors of ink to print the second test image are switched for each medium, and the first and second test images are printed with the ink of different colors on the same medium.

Incidentally, depending on a medium, a phenomenon in which an image printed on one surface is shown through the other surface, that is, a show-through, occurs. When the first and second test image printing regions are set in the same region of the first and second surfaces, the reading accuracy of the first and second test images may be reduced due to the show-through. However, by printing the first and second test images as described in this aspect of the invention, it is possible to reduce the influence of the show-through. Therefore, it is possible to prevent a reduction in the reading accuracy.

According to a sixth aspect of the invention, in the double-sided printing method according to the fifth aspect of the invention, in case black is included in the ink and a color of the first test image printed in the first test image printing region is set to black, a color of the second test image printed in the second test image printing region is set to black.

According to this aspect the invention, in the case where the first and second images are printed with the ink of a plurality of colors including black, in case the first test image is printed with black, the second test image is also printed with black. Since the influence of show-through on black is large, it is possible to reduce the influence of show-through by printing both surfaces with black.

According to a seventh aspect of the invention, in the double-sided printing method according to the fifth aspect of the invention, in case black is included in the ink and a color of the first test image printed in the first test image printing region is set to black, the second test image printing region is set to a blank.

According to this aspect the invention, in the case where the first and second images are printed with the ink of a plurality of colors including black, in case the first test image is printed with black, the second test image printing region is set to a blank. That is, in case the first test image is printed with black, the second test image is not printed on the second surface of the medium. Therefore, it is possible to reduce the influence of show-through. In particular, in a system that reads a test image immediately after the printing of each surface, the influence can be reduced. That is, in a system that reads a test image immediately after printing, the show-through of the test image on the first surface becomes a problem at the time of reading of the second surface. Therefore, in case printing the first test image with black that is largely influenced by show-through, a reduction in the reading accuracy of the second surface can be prevented by printing no test image on the second surface.

According to an eighth aspect of the invention, in the double-sided printing method according to the seventh aspect of the invention, in case a color of the second test image printed in the second test image printing region is set to black, the first test image printing region is set to a blank.

According to this aspect the invention, in the case where the first and second images are printed with the ink of a plurality of colors including black, in case the second test image is printed with black, the first test image printing region is set to a blank. That is, in case the second test image is printed with black, the first test image is not printed on the first surface of the medium. Therefore, it is possible to reduce the influence of show-through. In particular, in a system that reads a test image after double-sided printing, the influence can be reduced.

According to a ninth aspect of the invention, in the double-sided printing method according to any one of the first to fourth aspects of the invention, in case of printing the first and second images using ink of a plurality of colors, the first and second test images of the plurality of colors are disposed in the first and second test image printing regions, and colors of the first and second test images disposed in the same region are set to different colors.

According to the aspect of the invention, in case of printing the first and second images using ink of a plurality of colors, the first and second test images of the plurality of colors are printed in the first and second test image printing regions, and the first and second test images disposed in the same region are printed in different colors. For example, in case of printing the first and second images using the ink of four colors of cyan, magenta, yellow, and black, the first and second test images of four colors of cyan, magenta, yellow, and black are printed in the first and second test image printing regions. In this case, for example, in case the first test image is printed in the first test image printing region in order of cyan, magenta, yellow, and black, the second test image is printed in the second test image printing region in order of magenta, yellow, black, and cyan. Therefore, test images of different colors are printed in the corresponding regions of the front and back surfaces. According to this aspect of the invention, it is possible to check a plurality of colors in one medium and to reduce the influence of show-through.

According to a tenth aspect of the invention, in the double-sided printing method according to the ninth aspect of the invention, in case black is included in the ink, a region where the first test image is printed and a region where the second test image is printed are set in the same region for the black.

According to this aspect of the invention, in case the first and second images are printed with the ink of a plurality of colors including black, the region where the first test image is printed and the region where the second test image is printed are set in the same region of the front and back surfaces for the black. That is, the first and second test images are printed at the same position on front and back surfaces. Since the influence of show-through on black is large, it is possible to reduce the influence of show-through by printing the test image of black at the same position on the front and back surfaces.

According to an eleventh aspect of the invention, in the double-sided printing method according to the ninth aspect of the invention, in case black is included in the ink, a region of the second test image printing region corresponding to a region where the first test image of black is printed is set to a blank.

According to this aspect of the invention, in case the first and second images are printed with the ink of a plurality of colors including black, a region of the second test image printing region corresponding to a region where the first test image of black is printed is set to a blank. That is, the second test image is not printed at the position of the second surface corresponding to the position of the first surface where the first test image of black is printed. Therefore, it is possible to reduce the influence of show-through. In particular, in a system that reads a test image immediately after the printing of each surface, the influence can be reduced.

According to a twelfth aspect of the invention, in the double-sided printing method according to the eleventh aspect of the invention, a region of the first test image printing region corresponding to a region where the second test image of black is printed is set to a blank.

According to this aspect of the invention, a region of the first test image printing region corresponding to a region where the second test image of black is printed is also set to a blank. That is, nothing is printed behind the test image of black on both surfaces. Therefore, it is possible to reduce the influence of show-through. In particular, in a system that reads a test image after double-sided printing, the influence can be reduced.

According to a thirteenth aspect of the invention, in the double-sided printing method according to any one of the first to twelfth aspects of the invention, a density of the first test image printed in the first test image printing region is set to be lower than a density of the second test image printed in the second test image printing region.

According to this aspect of the invention, the first test image is printed with a lower density than the second test image. Therefore, it is possible to reduce the influence of show-through. In particular, in a system that reads a test image immediately after printing, the influence can be reduced.

According to a fourteenth aspect of the invention, in the double-sided printing method according to the thirteenth aspect of the invention, in case of printing the first and second test images in an ink jet method, the density of the first test image is set to be lower than the density of the second test image by changing a size of an ink droplet in case of printing the first test image and a size of an ink droplet in case of printing the second test image.

According to this aspect of the invention, in case the printing method is an ink jet method, the densities of the first and second test images are changed by changing the sizes of the ink droplets to be ejected. That is, the density of the first test image is set to be lower than the density of the second test image by changing the size of the ink droplet for printing the first test image so as to be relatively smaller than the size of the ink droplet for printing the second test image.

According to a fifteenth aspect of the invention, in the double-sided printing method according to any one of the first to fourteenth aspects of the invention, in case of printing the first and second test images in an ink jet method, each of the first and second test images is formed in a line pattern, and lines that form the first test image and lines that form the second test image are set so as not to overlap each other.

According to this aspect of the invention, in case the printing method is an ink jet method, each of the first and second test images is formed in a line pattern. In addition, lines that form the first test image and lines that form the second test image are set so as not to overlap each other (in case the second surface of the paper is seen therethrough from the first surface side, the lines that form the first test image and the lines that form the second test image are disposed so as not to overlap each other). That is, the positions of the lines are set so as to be shifted from each other. Therefore, since it is possible to reduce the influence of show-through, it is possible to prevent a reduction in the test image reading accuracy.

According to a sixteenth aspect of the invention, in the double-sided printing method according to any one of the first to fourteenth aspects of the invention, in case of printing the first and second test images in an ink jet method, each of the first and second test images is formed in a dot pattern, and dots that form the first test image and dots that form the second test image are set so as not to overlap each other.

According to this aspect of the invention, in case the printing method is an ink jet method, each of the first and second test images is formed in a dot pattern. In addition, dots that form the first test image and dots that form the second test image are set so as not to overlap each other (in case the second surface of the paper is seen therethrough from the first surface side, the dots that form the first test image and the dots that form the second test image are disposed so as not to overlap each other). That is, the positions of the dots are set so as to be shifted from each other. Therefore, since it is possible to reduce the influence of show-through, it is possible to prevent a reduction in the test image reading accuracy.

According to a seventeenth aspect of the invention, in the double-sided printing method according to any one of the first to fourteenth aspects of the invention, in case of printing the first and second test images in an ink jet method, each of the first and second test images is formed in a patch pattern, and patches that form the first test image and patches that form the second test image are set so as not to overlap each other.

According to this aspect of the invention, in case the printing method is an ink jet method, each of the first and second test images is formed in a patch pattern. In addition, patches that form the first test image and patches that form the second test image are set so as not to overlap each other (in case the second surface of the paper is seen therethrough from the first surface side, the patches that form the first test image and the patches that form the second test image are disposed so as not to overlap each other). That is, the positions of the patches are set so as to be shifted from each other. Therefore, since it is possible to reduce the influence of show-through, it is possible to prevent a reduction in the test image reading accuracy.

According to an eighteenth aspect of the invention, there is provided a double-sided printing apparatus that prints an image on first and second surfaces of a medium when one surface of the medium is the first surface and the other surface of the medium is the second surface, an end of the first surface on a front side from the first surface in a printing direction of the first surface is a first end of the medium, and an end of the first surface on a rear side from the first surface in the printing direction is a second end of the medium, including a first transportation unit that transports the medium by gripping the first end of the medium, a first printing unit that is provided on a transport path of the first transportation unit and prints a first image and a first test image in a single pass on the first surface of the medium transported by the first transportation unit, a reversing unit that reverses the first and second surfaces of the medium, a second transportation unit that transports the medium by gripping the second end of the medium reversed by the reversing unit, a second printing unit that is provided on a transport path of the second transportation unit and prints a second image and a second test image in a single pass on the second surface of the medium transported by the second transportation unit, and a print layout setting unit that sets a layout of the first image and the first test image to be printed on the first surface of the medium and a layout of the second image and the second test image to be printed on the second surface of the medium. The print layout setting unit sets a gripping region at each of the first and second ends of the medium gripped by the first and second transportation units, sets a region of the first surface excluding the gripping region as a first surface printable region and sets a first image printing region for printing the first image and a first test image printing region for printing the first test image in the first surface printable region, sets a region of the second surface excluding the gripping region as a second surface printable region and sets a second image printing region for printing the second image and a second test image printing region for printing the second test image in the second surface printable region, and sets the first and second test image printing regions in the same region of the first and second surfaces. The first transportation unit transports the medium by adsorbing and holding the medium on a peripheral surface of a rotary drum or a rotary belt, and the second transportation unit transports the medium by adsorbing and holding the medium on a peripheral surface of a rotary drum or a rotary belt. A first reading unit that is provided on the transport path of the first transportation unit and reads the first test image printed by the first printing unit and a second reading unit that is provided on the transport path of the second transportation unit and reads the second test image printed by the second printing unit are further included, in which, of a peripheral surface of a drum or a belt that forms the second transportation unit, a region in contact with the first test image printing region of the medium has a density equal to or greater than a highest density printable by the first printing unit.

According to this aspect of the invention, the medium is transported in a state where the first end is gripped by the first transportation unit. In addition, the first image and the first test image are printed in a single pass on the first surface by the first printing unit provided on the transport path of the first transportation unit in the transport process. Then, the front and back surfaces of the medium are reversed by the reversing unit. The reversed medium is transported in a state where the second end is gripped by the second transportation unit. In addition, the second image and the second test image are printed in a single pass on the second surface by the second printing unit provided on the transport path of the second transportation unit in the transport process.

The layout of the image printed on each surface of the medium is set by the print layout setting unit. The print layout setting unit sets the layout of the image printed on each surface as follows. First, a gripping region is set at each of the first and second ends of the medium. The gripping region is a region for gripping the medium during transport. A region of the first surface excluding the gripping region is set as a first surface printable region, and a first image printing region for printing the first image and a first test image printing region for printing the first test image are set in the first surface printable region. A region of the second surface excluding the gripping region is set as a second surface printable region, and a second image printing region for printing the second image and a second test image printing region for printing the second test image are set in the second surface printable region. In this case, the first and second test image printing regions are set in the same region of the first and second surfaces. That is, the second test image printing region is set directly behind the first test image printing region. In other words, the first and second test image printing regions are set at positions overlapping each other when the medium is seen therethrough from one surface side of the medium. Therefore, even when printing a test image on both sides of the medium, it is possible to secure wide printable regions for the first and second images as images to be printed, that is, the wide first and second image printing regions.

According to a nineteenth aspect of the invention, there is provided a double-sided printing apparatus, including a transportation unit that transports a medium by gripping an end of the medium on a front side in a printing direction of the medium, a printing unit that is provided on a transport path of the transportation unit and prints an image in a single pass on one surface of the medium transported by the transportation unit, and a reverse transportation unit that receives, from the transportation unit, the medium having one surface on which the image is printed, reverses the medium, and feeds the medium to the transportation unit again. When one surface of the medium is a first surface and the other surface of the medium is a second surface, an end of the first surface on a front side from the first surface in a printing direction of the first surface is a first end of the medium, an end of the first surface on a rear side from the first surface in the printing direction is a second end of the medium, a first image and a first test image are printed on the first surface of the medium in first printing and a second image and a second test image are printed on the second surface of the medium in second printing. A print layout setting unit that sets a layout of the first image and the first test image to be printed on the first surface of the medium and a layout of the second image and the second test image to be printed on the second surface of the medium is provided. The print layout setting unit sets a gripping region at each of the first and second ends of the medium gripped by the transportation unit, sets a region of the first surface excluding the gripping region as a first surface printable region and sets a first image printing region for printing the first image and a first test image printing region for printing the first test image in the first surface printable region, sets a region of the second surface excluding the gripping region as a second surface printable region and sets a second image printing region for printing the second image and a second test image printing region for printing the second test image in the second surface printable region, and sets the first and second test image printing regions in the same region of the first and second surfaces.

According to this aspect of the invention, the medium is transported first in a state where the first end is gripped by the transportation unit. In addition, the first image and the first test image are printed in a single pass on the first surface by the printing unit in the transport process. Then, the front and back surfaces of the medium are reversed by the reverse transportation unit, and the medium is fed to the transportation unit again. The medium fed to the transportation unit again is transported in a state where the second end is gripped. In addition, the second image and the second test image are printed in a single pass on the second surface by the printing unit in the transport process. The layout of the image printed on each surface of the medium is set by the print layout setting unit. The setting procedure is the same as the setting procedure of the print layout by the print layout setting unit described in the eighteenth aspect of the invention.

According to a twentieth aspect of the invention, in the double-sided printing apparatus according to the eighteenth aspect or the nineteenth aspect of the invention, the print layout setting unit sets a deformed region of the medium in case of transporting the medium by gripping the first end as a gripping region of the first end, and sets a deformed region of the medium in case of transporting the medium by gripping the second end as a gripping region of the second end.

According to this aspect of the invention, the gripping region is set in consideration of the deformation (grip marks, wrinkles, or the like) of the medium at the time of gripping. Therefore, since it is possible to prevent the deformation of the first and second test images, it is possible to prevent a reduction in the reading accuracy.

According to a twenty-first aspect of the invention, in the double-sided printing apparatus according to the eighteenth to twentieth aspects of the invention, the print layout setting unit sets the first test image printing region at an end of the first surface printable region on the first end side or on the second end side.

According to this aspect of the invention, the first test image printing region is set at the end of the first surface printable region on the first end side or on the second end side. Therefore, the first and second test images can be cut together with the gripping region.

According to a twenty-second aspect of the invention, in the double-sided printing apparatus according to any one of the eighteenth to twenty-first aspects of the invention, in case of printing the first and second images using ink of a plurality of colors, the print layout setting unit may set the colors of ink to print the first test image and the colors of ink to print the second test image so as to be switched for each medium, and may set the colors of ink to print the first test image and the colors of ink to print the second test image to different colors on the same medium.

According to this aspect of the invention, in case of printing the first and second images using the ink of a plurality of colors, the colors of ink to print the first test image and the colors of ink to print the second test image are switched for each medium. In addition, the colors of ink to print the first test image and the colors of ink to print the second test image are set to different colors on the same medium. Therefore, since it is possible to reduce the influence of show-through, it is possible to prevent a reduction in the reading accuracy.

According to a twenty-third aspect of the invention, in the double-sided printing apparatus according to the twenty-second aspect of the invention, in case black is included in ink, the print layout setting unit may set the color of the second test image printed in the second test image printing region to black in case the color of the first test image printed in the first test image printing region is set to black.

According to this aspect the invention, in the case where the first and second images are printed with the ink of a plurality of colors including black, in case the first test image is printed with black, the second test image is also printed with black. Since the influence of show-through on black is large, it is possible to reduce the influence of show-through by printing both surfaces with black.

According to a twenty-fourth aspect of the invention, in the double-sided printing apparatus according to the twenty-second aspect of the invention, in case black is included in the ink, the second test image printing region may be set to a blank in case the color of the first test image printed in the first test image printing region is set to black.

According to this aspect the invention, in the case where the first and second images are printed with the ink of a plurality of colors including black, in case the first test image is printed with black, the second test image printing region is set to a blank. That is, in case the first test image is printed with black, the second test image is not printed on the second surface of the medium. Therefore, it is possible to reduce the influence of show-through. In particular, in a system that reads a test image immediately after the printing of each surface, for example, in a system in which a reading unit that reads a test image is provided on the transport path of the transportation unit, the influence can be reduced.

According to a twenty-fifth aspect of the invention, in the double-sided printing apparatus according to the twenty-fourth aspect of the invention, in case the color of the second test image printed in the second test image printing region is set to black, the print layout setting unit may set the first test image printing region to a blank.

According to this aspect the invention, in the case where the first and second images are printed with the ink of a plurality of colors including black, in case the second test image printing region is printed with black, the first test image is set to a blank. That is, in case the second test image is printed with black, the first test image is not printed on the first surface of the medium. Therefore, it is possible to reduce the influence of show-through. In particular, in a system that reads a test image after double-sided printing, the influence can be reduced.

According to a twenty-sixth aspect of the invention, in the double-sided printing apparatus according to any one of the eighteenth to twenty-first aspects of the invention, in case of printing the first and second images using ink of a plurality of colors, the print layout setting unit may dispose the first and second test images of the plurality of colors in the first and second test image printing regions, and set the colors of the first and second test images disposed in the same region to different colors.

According to the aspect of the invention, in case of printing the first and second images using ink of a plurality of colors, the first and second test images of the plurality of colors are printed in the first and second test image printing regions, and the first and second test images disposed in the same region are printed in different colors. Therefore, it is possible to check a plurality of colors in one medium and to reduce the influence of show-through.

According to a twenty-seventh aspect of the invention, in the double-sided printing apparatus according to the twenty-sixth aspect of the invention, in case black is included in the ink, the print layout setting unit may set a region where the first test image is printed and a region where the second test image is printed in the same region for the black.

According to this aspect of the invention, in case the first and second images are printed with the ink of a plurality of colors including black, the region where the first test image is printed and the region where the second test image is printed are set in the same region of the front and back surfaces for the black. That is, the first and second test images are printed at the same position on front and back surfaces. Therefore, it is possible to reduce the influence of show-through.

According to a twenty-eighth aspect of the invention, in the double-sided printing apparatus according to the twenty-sixth aspect of the invention, in case black is included in the ink, the print layout setting unit may set a region of the second test image printing region corresponding to a region where the first test image of black is printed to a blank.

According to this aspect of the invention, in case the first and second images are printed with the ink of a plurality of colors including black, a region of the second test image printing region corresponding to a region where the first test image of black is printed is set to a blank. That is, the second test image is not printed at the position of the second surface corresponding to the position of the first surface where the first test image of black is printed. Therefore, it is possible to reduce the influence of show-through. In particular, in a system that reads a test image immediately after the printing of each surface, the influence can be reduced.

According to a twenty-ninth aspect of the invention, in the double-sided printing apparatus according to the twenty-eighth aspect of the invention, the print layout setting unit may set a region of the first test image printing region corresponding to a region where the second test image of black is printed to a blank.

According to this aspect of the invention, a region of the first test image printing region corresponding to a region where the second test image of black is printed is also set to a blank. That is, nothing is printed behind the test image of black on both surfaces. Therefore, it is possible to reduce the influence of show-through. In particular, in a system that reads a test image after double-sided printing, the influence can be reduced.

According to a thirtieth aspect of the invention, in the double-sided printing apparatus according to any one of the eighteenth to twenty-ninth aspects of the invention, the print layout setting unit may set a density of the first test image printed in the first test image printing region to be lower than a density of the second test image printed in the second test image printing region.

According to this aspect of the invention, the first test image is printed with a lower density than the second test image. Therefore, it is possible to reduce the influence of show-through. In particular, in a system that reads a test image immediately after printing, the influence can be reduced.

According to a thirty-first aspect of the invention, in the double-sided printing apparatus according to the twenty-ninth aspect of the invention, in case of printing the first and second test images in an ink jet method, the print layout setting unit may set the density of the first test image to be lower than the density of the second test image by changing a size of an ink droplet in case of printing the first test image and a size of an ink droplet in case of printing the second test image.

According to this aspect of the invention, in the case of a printing apparatus using a printing method of an ink jet method, the densities of the first and second test images are changed by changing the sizes of the ink droplets to be ejected. That is, the density of the first test image is set to be lower than the density of the second test image by changing the size of the ink droplet for printing the first test image so as to be relatively smaller than the size of the ink droplet for printing the second test image.

According to a thirty-second aspect of the invention, in the double-sided printing apparatus according to any one of the eighteenth to thirty-first aspects of the invention, in case of printing the first and second test images in an ink jet method, the print layout setting unit may form each of the first and second test images in a line pattern, and may set lines that form the first test image and lines that form the second test image so as not to overlap each other.

According to this aspect of the invention, in the case of a printing apparatus using a printing method of an ink jet method, each of the first and second test images is formed in a line pattern. In addition, the lines that form the first test image and the lines that form the second test image are set so as not to overlap each other. That is, the positions of the lines are set so as to be shifted from each other. Therefore, since it is possible to reduce the influence of show-through, it is possible to prevent a reduction in the test image reading accuracy.

According to a thirty-third aspect of the invention, in the double-sided printing apparatus according to any one of the eighteenth to thirty-first aspects of the invention, in case of printing the first and second test images in an ink jet method, the print layout setting unit may form each of the first and second test images in a dot pattern, and may set dots that form the first test image and dots that form the second test image so as not to overlap each other.

According to this aspect of the invention, in the case of a printing apparatus using a printing method of an ink jet method, each of the first and second test images is formed in a dot pattern. In addition, the dots that form the first test image and the dots that form the second test image are set so as not to overlap each other. That is, the positions of the dots are set so as to be shifted from each other. Therefore, since it is possible to reduce the influence of show-through, it is possible to prevent a reduction in the test image reading accuracy.

According to a thirty-fourth aspect of the invention, in the double-sided printing apparatus according to any one of the eighteenth to thirty-first aspects of the invention, in case of printing the first and second test images in an ink jet method, the print layout setting unit may form each of the first and second test images in a patch pattern, and may set patches that form the first test image and patches that form the second test image so as not to overlap each other.

According to this aspect of the invention, in the case of a printing apparatus using a printing method of an ink jet method, each of the first and second test images is formed in a patch pattern. In addition, the patches that form the first test image and the patches that form the second test image are set so as not to overlap each other. That is, the positions of the patches are set so as to be shifted from each other. Therefore, since it is possible to reduce the influence of show-through, it is possible to prevent a reduction in the test image reading accuracy.

According to a thirty-fifth aspect of the invention, in the double-sided printing apparatus according to the eighteenth aspect of the invention, the first transportation unit may transport the medium by adsorbing and holding the medium on a peripheral surface of a rotary drum or a rotary belt, and the second transportation unit may transport the medium by adsorbing and holding the medium on a peripheral surface of a rotary drum or a rotary belt. A first reading unit that is provided on the transport path of the first transportation unit and reads the first test image printed by the first printing unit and a second reading unit that is provided on the transport path of the second transportation unit and reads the second test image printed by the second printing unit may be further included. Of a peripheral surface of a drum or a belt that forms the second transportation unit, a region in contact with the first test image printing region of the medium may have a density equal to or greater than a highest density printable by the first printing unit.

According to this aspect of the invention, the first transportation unit transports the medium by adsorbing and holding the medium on the peripheral surface of the rotary drum or the rotary belt. Similarly, the second transportation unit transports the medium by adsorbing and holding the medium on the peripheral surface of the rotary drum or the rotary belt. The first reading unit that reads the first test image printed by the first printing unit is provided on the transport path of the first transportation unit, and the second reading unit that reads the second test image printed by the second printing unit is provided on the transport path of the second transportation unit. Therefore, according to this aspect of the invention, the test image printed on each surface is read immediately after printing. That is, for example, the first test image is read before the second surface is printed. In addition, according to this aspect of the invention, at least a part of the peripheral surface of the drum or the belt that forms the second transportation unit is formed so as to have a fixed density or higher. That is, of the peripheral surface of the drum or the belt that forms the second transportation unit, a region that is brought into contact with the first test image printing region in case of adsorbing and holding the medium, that is, a region overlapping the printed first test image is formed so as to have a density equal to or greater than a highest density printable by the first printing unit. In this case, it is possible to prevent a reduction in the reading accuracy of the second test image due to the show-through.

According to a thirty-sixth aspect of the invention, in the double-sided printing apparatus according to the nineteenth aspect of the invention, the transportation unit may transport the medium by adsorbing and holding the medium on a peripheral surface of a rotary drum or a rotary belt. A reading unit that is provided on the transport path of the transportation unit and reads an image printed on the medium may be further included. Of a peripheral surface of a drum or a belt that forms the transportation unit, a region in contact with the first test image printing region of the medium has a density equal to or greater than a highest density printable by the printing unit.

According to this aspect of the invention, the transportation unit transports the medium by adsorbing and holding the medium on the peripheral surface of the rotary drum or the rotary belt. On the transport path of the transportation unit, the reading unit that reads the first and second test images printed by the printing unit is provided. Therefore, according to this aspect of the invention, the test image printed on each surface is read immediately after printing. In addition, according to this aspect of the invention, at least a part of the peripheral surface of the drum or the belt that forms the transportation unit is formed so as to have a fixed density or higher. That is, of the peripheral surface of the drum or the belt that forms the transportation unit, a region that is brought into contact with the first test image printing region in case of adsorbing and holding the medium, that is, a region overlapping the printed first test image, is formed so as to have a density equal to or greater than a highest density printable by the printing unit. In this case, it is possible to prevent a reduction in the reading accuracy of the second test image due to the show-through.

According to the invention, even when printing a test image on both sides of the medium, it is possible to secure a wide printable region for an image to be printed.

### BRIEF DESCRIPTION OF THE DRAWINGS

FIG. 1 is a diagram showing the overall configuration of a double-sided printing apparatus according to a first embodiment.

FIG. 2 is a perspective view showing the schematic configuration of a first printing unit.

FIGS. 3A to 3F are diagrams for explaining the operation of a reversing drum when reversing the front and back surfaces of paper.

FIGS. 4A to 4C are diagrams for explaining the operation of a reversing drum when the front and back surfaces of paper are not reversed.

FIG. 5 is a block diagram showing the schematic configuration of a control system of a double-sided printing apparatus.

FIG. 6 is a functional block diagram of a print layout setting unit realized by a system controller.

FIG. 7 is a diagram showing an example of a test image.

FIG. 8 is a conceptual diagram of the detection of a discharge failure nozzle and a discharge direction failure nozzle using the test image shown in FIG. 7.

FIG. 9 is a diagram showing an example of a test image.

FIG. 10 is a diagram showing an example of a test image.

FIG. 11 is a conceptual diagram of the setting of a gripping region.

FIG. 12 is a functional block diagram of an image processing unit realized by a system controller.

FIGS. 13A and 13B are conceptual diagrams of a paper transport form at the time of double-sided printing.

FIG. 14 is a conceptual diagram of the setting of the print layout at the time of single-sided printing.

FIG. 15 is a diagram showing an example of a test image to be printed on paper.

FIGS. 16A to 16D are diagrams showing an example of a test image to be printed on paper.

FIGS. 17A and 17B are conceptual diagrams of the setting of the print layout at the time of double-sided printing.

FIGS. 18A and 18B are diagrams showing an example of a print result at the time of double-sided printing.

FIGS. 19A and 19B are diagrams showing a modification example of the print layout at the time of double-sided printing.

FIG. 20 is a diagram showing another printing example of a test image formed in a line pattern.

FIG. 21 is a diagram showing still another printing example of the test image formed in a dot pattern.

FIG. 22 is a diagram showing still another printing example of the test image formed by density patches.

FIGS. 23A and 23B are diagrams showing an example of changing the density of the test image in the case of printing using an ink jet method.

FIG. 24 is a table showing an example of setting ink colors used in the printing of a first test image and ink colors used in the printing of a second test image.

FIGS. 25A and 25B are diagrams showing a printing example when changing the colors of test images printed in the corresponding regions on the front and back surfaces of paper in the case of checking all ink jet heads provided in a printing unit at once.

FIG. 26 is a table showing an example of setting ink colors used in the printing of a first test image and ink colors used in the printing of a second test image.

FIG. 27 is a table showing an example of setting ink colors used in the printing of a first test image and ink colors used in the printing of a second test image.

FIG. 28 is a perspective view of a second printing drum whose part of the peripheral surface is colored.

FIG. 29 is a diagram showing the overall configuration of a double-sided printing apparatus according to a second embodiment.

### DESCRIPTION OF THE PREFERRED EMBODIMENTS

Hereinafter, embodiments of the invention will be described in detail with reference to the accompanying diagrams.

### First Embodiment

### Overall Configuration of a Double-Sided Printing Apparatus

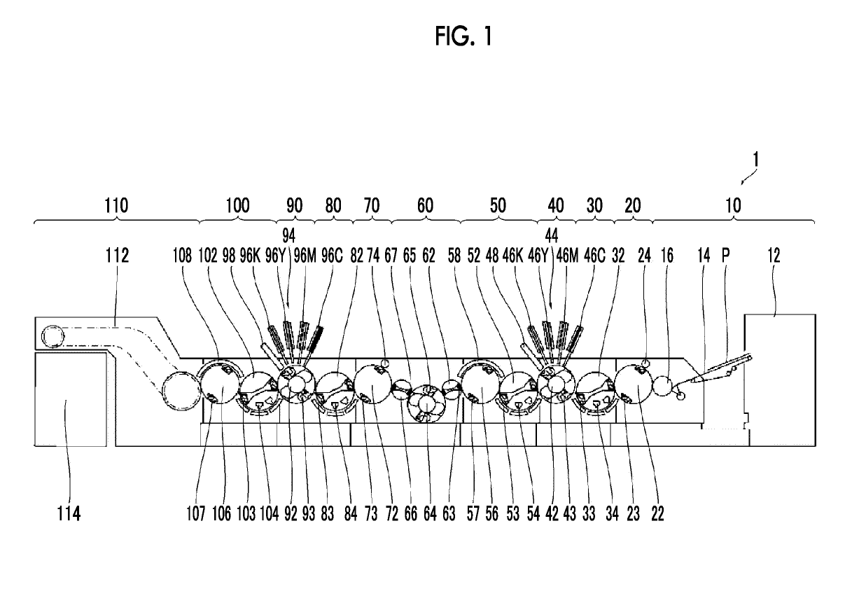

FIG. 1 is a diagram showing the overall configuration of a double-sided printing apparatus according to a first embodiment. A double-sided printing apparatus 1 is a printing apparatus for printing an image on both sides of a sheet (hereinafter, referred to as paper) using an ink jet method, and prints an image on each side of the paper with printing units provided in two places.

As shown in FIG. 1, the double-sided printing apparatus 1 is mainly configured to include a paper feed unit 10 that feeds paper P, a first processing liquid application unit 20 that applies a predetermined processing liquid onto a first surface (front printing surface) of the paper P fed from the paper feed unit 10, a first processing liquid drying unit 30 that dries the paper P having the first surface onto which the processing liquid has been applied, a first printing unit 40 that prints an image on the first surface of the dried paper P using an ink jet method, a first ink drying unit 50 that dries the paper P having the first surface on which the image is printed, a reversing unit 60 that reverses the front and back surfaces of the dried paper P, a second processing liquid application unit 70 that applies a predetermined processing liquid onto a second surface (back printing surface) of the paper P whose front and back surfaces have been reversed, a second processing liquid drying unit 80 that dries the paper P having the second surface onto which the processing liquid has been applied, a second printing unit 90 that prints an image on the second surface of the dried paper P using an ink jet method, a second ink drying unit 100 that dries the paper P having the second surface on which the image is printed, and a stacking unit 110 that stacks the dried paper P.

### Paper

As paper (sheet) P that is an example of media, for example, general-purpose coated paper for printing (art paper, coated paper, lightweight coated paper, cast paper, fine coated paper, and the like), which is used in general offset printing or the like, is used. In addition, the media type is not particularly limited, and may be appropriately selected according to the printing purpose or application.

### Paper Feed Unit

The paper feed unit 10 feeds the paper P, which is a medium, one by one. As shown in FIG. 1, the paper feed unit 10 is mainly configured to include a paper feeder 12, a feeder board 14, and a feed drum 16.

The paper feeder 12 takes out the paper P, which is set at a predetermined position in a state of a paper bundle, sequentially from the top, and feeds the paper P to the feeder board 14 one by one.

The feeder board 14 receives the paper P fed from the paper feeder 12 one by one, transports the received paper P along the predetermined transport path, and passes the paper P to the feed drum 16.

The feed drum 16 receives the paper P fed from the feeder board 14, transports the received paper P along the predetermined transport path, and passes the paper P to the first processing liquid application unit 20. The feed drum 16 has a cylindrical shape, and rotates in a state in which the end of the paper P on the front side in the transport direction is gripped by a gripper 17 provided on the peripheral surface so that the paper P is transported in a state of being wound on the peripheral surface.

### First Processing Liquid Application Unit

The first processing liquid application unit 20 applies a predetermined processing liquid onto the first surface of the paper P. The processing liquid to be applied herein is a liquid having a function of aggregating, insolubilizing, and thickening color material components of the ink used in the first printing unit 40 located in the subsequent stage. By applying such a processing liquid in advance (precoating) for the sake of printing, it is possible to perform high-quantity printing even when general-purpose printing paper.

As shown in FIG. 1, the first processing liquid application unit 20 is mainly configured to include a first processing liquid application drum 22 for transporting the paper P and a first processing liquid application device 24 for applying the processing liquid onto the first surface of the paper P transported by the first processing liquid application drum 22.

The first processing liquid application drum 22 receives the paper P from the feed drum 16 of the paper feed unit 10, transports the received paper P along the predetermined transport path, and passes the paper P to the first processing liquid drying unit 30. The first processing liquid application drum 22 has a cylindrical shape, and rotates in a state in which the end of the paper P on the front side in the transport direction is gripped by a gripper 23 provided on the peripheral surface so that the paper P is transported in a state of being wound on the peripheral surface. In this case, the paper P is transported in a state of being wound on the peripheral surface of the first processing liquid application drum 22 with the first surface being outwardly directed.

The first processing liquid application device 24 applies the processing liquid onto the first surface of the paper P transported by the first processing liquid application drum 22. In the present embodiment, the processing liquid is applied using a roller. That is, the processing liquid is applied by pressing a roller (coating roller) having a processing liquid on its peripheral surface against a first surface F1 of the paper P transported by the first processing liquid application drum 22. The method of applying the processing liquid is not limited to this, and it is also possible to use an application method using an ink jet head, an application method using a spray, and the like.

The first processing liquid application unit 20 is configured as described above. The processing liquid is applied (pre-coated) onto the first surface F1 of the paper P while the paper P is being transported by the first processing liquid application drum 22.

### First Processing Liquid Drying Unit

The first processing liquid drying unit 30 dries the paper P having the first surface F1 onto which the processing liquid has been applied. The first processing liquid drying unit 30 is mainly configured to include a first processing liquid drying drum 32 for transporting the paper P and a first processing liquid drying device 34 for drying the paper P by blowing warm air to the paper P transported by the first processing liquid drying drum 32.

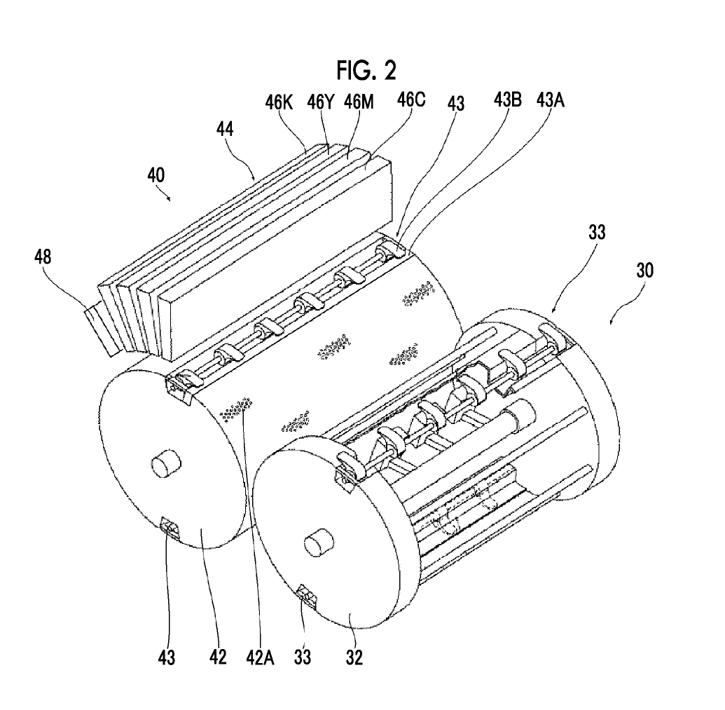

The first processing liquid drying drum 32 receives the paper P from the first processing liquid application drum 22 of the first processing liquid application unit 20, transports the received paper P along the predetermined transport path, and passes the paper P to the first printing unit 40. The first processing liquid drying drum 32 is formed by a frame body having a cylindrical shape, and rotates in a state in which the end of the paper P on the front side in the transport direction is gripped by a gripper 33 provided on the peripheral surface so that the paper P is transported (refer to FIG. 2). In this case, the paper P is transported in a state in which the first surface F1 onto which the processing liquid has been applied is inwardly directed.

The first processing liquid drying device 34 is provided inside the first processing liquid drying drum 32, and blows warm air toward the paper P transported by the first processing liquid drying drum 32.

The first processing liquid drying unit 30 is configured as described above. The warm air is blown to the first surface F1 while the paper P is being transported by the first processing liquid drying drum 32, so that the paper P is dried.

### First Printing Unit

The first printing unit 40 prints a color image on the first surface F1 of the paper P in the ink jet method using the ink of four colors of cyan (C), magenta (M), yellow (Y), and black (K). As shown in FIG. 1, the first printing unit 40 is mainly configured to include a first printing drum 42 for transporting the paper P, a first head unit 44 that prints a color image on the first surface F1 of the paper P by discharging ink droplets of the colors of C, M, Y, and K toward the first surface F1 of the paper P transported by the first printing drum 42, and a first scanner 48 that reads the image printed on the first surface F1 of the paper P.

The first printing drum 42 receives the paper P from the first processing liquid drying drum 32 of the first processing liquid drying unit 30, transports the received paper P along the predetermined transport path (first transport path), and passes the paper P to the first ink drying unit 50. The first printing drum 42 is an example of a first transportation unit.

FIG. 2 is a perspective view showing the schematic configuration of the first printing unit 40 including the first printing drum 42. As shown in FIG. 2, the first printing drum 42 has a cylindrical shape, and rotates in a state in which the end of the paper P on the front side in the transport direction is gripped by a gripper 43 provided on the peripheral surface so that the paper P is transported in a state of being wound on the peripheral surface. In this case, the paper P is transported in a state of being wound on the peripheral surface of the first printing drum 42 with the first surface, which is the front printing surface, being outwardly directed.

The gripper 43 includes a gripper pad 43A and a plurality of gripping claws 43B, and grips the end of the paper P on the front side in the transport direction by gripping the end of the paper P on the front side in the transport direction between the gripper pad 43A and the gripping claws 43B. The gripper pad 43A is disposed in parallel to the rotational axis of the first printing drum 42. The gripping claws 43B are disposed at fixed distances along the gripper pad 43A, and are provided so as to be movable toward or away from the gripper pad 43A. By the movement of the gripping claws 43B toward or away from the gripper pad 43A, the gripper 43 is opened and closed. The gripper 43 receives the paper P, and is opened and closed in conjunction with the passing of the paper P.

Grippers of other drums excluding a reversing drum 66 of the reversing unit 60 also have the same configuration. In order to prevent the gripping claws of adjacent drums from interfering with each other, the arrangement positions of the gripping claws are shifted in the axial direction of each drum.

The first printing drum 42 includes a suction mechanism in order to increase the adhesion to the peripheral surface of the paper P. In the present embodiment, the paper P is adsorbed and held on the peripheral surface using negative pressure. The first printing drum 42 includes a number of suction holes 42A on the peripheral surface, and adsorbs and holds the paper P on the peripheral surface by suction from the inside. In addition, a method of using the static electricity or the like can also be adopted as the suction mechanism.

The first head unit 44 is an example of the first printing unit, and is configured to include an ink jet head 46C for discharging ink droplets of cyan, an ink jet head 46M for discharging ink droplets of magenta, an ink jet head 46Y for discharging ink droplets of yellow, and an ink jet head 46K for discharging ink droplets of black. The ink jet heads 46C, 46M, 46Y, and 46K are disposed on the transport path (first transport path) of the paper P by the first printing drum 42.

Each of the ink jet heads 46C, 46M, 46Y, and 46K is formed by a line head that can perform printing in a single pass on the paper P transported by the first printing drum 42. Each of the ink jet heads 46C, 46M, 46Y, and 46K includes a nozzle surface in its tip portion, and discharges ink droplets toward the paper P transported by the first printing drum 42 from the nozzles disposed on the nozzle surface.

As ink, for example, aqueous ink (ink using an aqueous medium) is used. In addition, the type of ink to be used is not particularly limited, and can be appropriately selected depending on the application, purpose, or the like.

As shown in FIG. 1, the first scanner 48 is provided on the downstream side of the first head unit 44 with respect to the transport direction of the paper P by the first printing drum 42. The first scanner 48 reads the image printed on the first surface F1 of the paper P by the first head unit 44. The first scanner 48 is a line scanner, for example. The first scanner 48 is an example of a first reading unit.

The first printing unit 40 is configured as described above. Ink droplets of the colors of C, M, Y, and K from the ink jet heads 46C, 46M, 46Y, and 46K that form the first head unit 44 are ejected onto the first surface F1 of the paper P while the paper P is being transported by the first printing drum 42. As a result, a color image is printed on the first surface F1. The image printed on the first surface F1 is read by the first scanner 48 when the paper P passes through the first scanner 48.

### First Ink Drying Unit

The first ink drying unit 50 dries the paper P immediately after the printing by the first printing unit 40. As shown in FIG. 1, the first ink drying unit 50 is mainly configured to include a first pre-drying drum 52 for transporting the paper P, a first pre-drying device 54 that pre-dries the paper P by blowing warm air to the paper P transported by the first pre-drying drum 52, a first ink drying drum 56 for transporting the paper P, and a first ink drying device 58 that dries the paper P by blowing warm air to the paper P transported by the first ink drying drum 56.

The first pre-drying drum 52 receives the paper P from the first printing drum 42 of the first printing unit 40, transports the received paper P along the predetermined transport path, and passes the paper P to the first ink drying drum 56. The first pre-drying drum 52 is formed by a frame body having a cylindrical shape, and rotates in a state in which the end of the paper P on the front side in the transport direction is gripped by a gripper 53 provided on the peripheral surface so that the paper P is transported. In this case, the paper P is transported in a state in which the printed first surface F1 is inwardly directed.

The first pre-drying device 54 is provided inside the first pre-drying drum 52, and blows warm air toward the paper P transported by the first pre-drying drum 52.

The first ink drying drum 56 receives the paper P from the first pre-drying drum 52, transports the received paper P along the predetermined transport path, and passes the paper P to the reversing unit 60. The first ink drying drum 56 has a cylindrical shape, and rotates in a state in which the end of the paper P on the front side in the transport direction is gripped by a gripper 55 provided on the peripheral surface so that the paper P is transported in a state of being wound on the peripheral surface. In this case, the paper P is transported in a state in which the printed first surface F1 is outwardly directed.

The first ink drying device 58 is provided on the transport path of the paper P by the first ink drying drum 56, and blows warm air toward the paper P transported by the first ink drying drum 56.

The first ink drying unit 50 is configured as described above. The paper P is transported while being passed from the first pre-drying drum 52 to the first ink drying drum 56, and is dried by warm air blown to the first surface F1 in the transport process.

### Reversing Unit

The reversing unit 60 reverses the front and back surfaces of the paper P by reversing the front and rear sides of the paper P. That is, by rotating the paper P by 180° along the transport direction so that the front and rear sides of the paper P are reversed, the front and back surfaces of the paper P are reversed. As shown in FIG. 1, the reversing unit 60 is mainly configured to include a first pass drum 62, a second pass drum 64, and a reversing drum 66.

The first pass drum 62 receives the paper P from the first ink drying drum 56 of the first ink drying unit 50, transports the received paper P along the predetermined transport path, and passes the paper P to the second pass drum 64. The first pass drum 62 has a cylindrical shape, and rotates in a state in which the end of the paper P on the front side in the transport direction is gripped by a gripper 63 provided on the peripheral surface so that the paper P is transported. In this case, the paper P is transported in a state in which the printed first surface F1 is inwardly directed.

The second pass drum 64 receives the paper P from the first pass drum 62, transports the received paper P along the predetermined transport path, and passes the paper P to the reversing drum 66. The second pass drum 64 has a cylindrical shape, and rotates in a state in which the end of the paper P on the front side in the transport direction is gripped by a gripper 65 provided on the peripheral surface so that the paper P is transported. In this case, the paper P is transported in a state in which the printed first surface F1 is outwardly directed.

The reversing drum 66 receives the paper P from the second pass drum 64, transports the received paper P along the predetermined transport path, and passes the paper P to the second processing liquid application unit 70. The reversing drum 66 grips the rear end of the paper P when receiving the paper P from the second pass drum 64, thereby reversing the front and back surfaces of the paper P in the transport process. The reversing drum 66 can also transport the paper P without reversing the paper P. For example, at the time of single-sided printing, the reversing drum 66 transports the paper P without reversing the paper P. In this case, when receiving the paper P from the second pass drum 64, the reversing drum 66 receives the paper P by gripping the end of the paper P on the front side in the transport direction.

The reversing drum 66 has a cylindrical shape, and rotates in a state in which the paper P is gripped by a reversing gripper 67 provided on the peripheral surface so that the paper P is transported. The reversing gripper 67 is a two claw type gripper for gripping the paper P with a parent claw and a child claw, and is provided so as to be able to swing around the spindle. When reversing the front and back surfaces of the paper P, the direction of gripping the paper P is changed by the swinging of the reversing gripper 67 in conjunction with the rotation of the reversing drum 66.

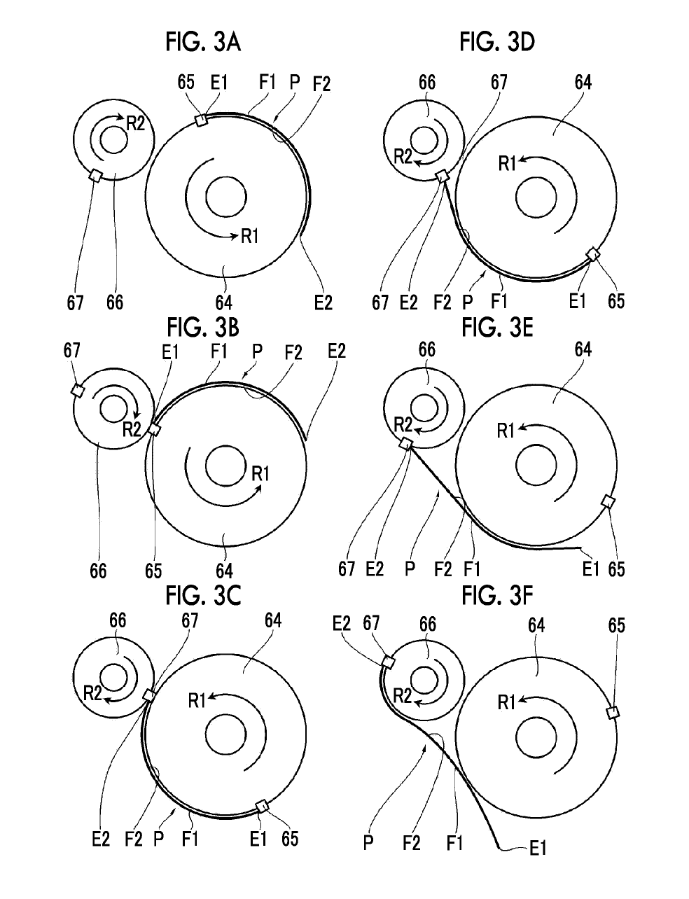

FIGS. 3A to 3F are diagrams for explaining the operation of the reversing drum when reversing the front and back surfaces of the paper P.

In the diagrams, reference numerals P, F1, F2, E1, E2, R1, and R2 indicate paper, a first surface of the paper P, a second surface of the paper P, a first end of the paper P, a second end of the paper P, a rotation direction of the second pass drum 64, and a rotation direction of the reversing drum 66, respectively.

The first end E1 of the paper P is an end (front end) of the paper P on the front side in the printing direction (synonymous with the transport direction of the paper P in the double-sided printing apparatus 1 of the present embodiment) when printing the first surface F1 of the paper P. In addition, the second end E2 of the paper P is an end (rear end) of the paper P on the rear side in the printing direction when printing the first surface F1 of the paper P. Accordingly, at the time of printing of the first surface F1, the first end E1 is an end of the paper P on the front side in the transport direction.

In addition, the rotation direction R1 of the second pass drum 64 is a counterclockwise direction, and the rotation direction of the reversing drum 66 is a clockwise direction.

Passing of the paper P from the second pass drum 64 to the reversing drum 66 is performed at a contact point between the second pass drum 64 and the reversing drum 66, that is, at an intersection between the straight line, which connects the center of the second pass drum 64 and the center of the reversing drum 66 to each other, and the second pass drum 64 and the reversing drum 66.

Reversing of the paper P is performed in the process of passing the paper P from the second pass drum 64 to the reversing drum 66.

FIG. 3A shows a state before passing the paper P to the reversing drum 66, that is, a state in the middle of transporting the paper P by the second pass drum 64. In this state, the paper P is transported in a state in which the first end E1, which is an end on the front side in the transport direction, is gripped by the gripper 65 of the second pass drum 64. In addition, the paper P is transported in a state in which the first surface F1 is outwardly directed.

FIG. 3B also shows a state before passing the paper P to the reversing drum 66. In particular, FIG. 3B also shows a state in which the gripper 65 of the second pass drum 64 has reached the contact point. When transporting the paper P without reversing the front and back surfaces, the paper P is passed to the reversing drum 66 from the second pass drum 64 in this stage. The case of transporting the paper P without reversing the front and back surfaces will be described later.

FIG. 3C shows a state of the moment of passing the paper P from the second pass drum 64 to the reversing drum 66. Passing of the paper P is performed in a stage in which the rear end (here, the second end E2) of the paper P transported by the second pass drum 64 has reached the contact point. That is, when the rear end (second end E2) of the paper P transported by the second pass drum 64 reaches the contact point, the rear end (second end E2) of the paper P is gripped by the reversing gripper 67 of the reversing drum 66. On the other hand, the gripping of the front end (first end E1) of the paper P by the gripper 65 of the second pass drum 64 is released. Accordingly, the passing of the paper P is performed.

FIG. 3D shows a state in the middle of passing the paper P. The paper P having the rear end (second end E2) gripped by the reversing gripper 67 of the reversing drum 66 is pulled away from the peripheral surface of the second pass drum 64 by the rotation of the reversing drum 66. In addition, the reversing gripper 67 swings in conjunction with the rotation of the reversing drum 66, and the direction of gripping the paper P is changed.

FIG. 3E shows a state in which the rotation of the reversing drum 66 has further progressed. The paper P having the rear end (second end E2) gripped by the reversing gripper 67 of the reversing drum 66 is pulled away from the peripheral surface of the second pass drum 64 by the rotation of the reversing drum 66. Accordingly, the front and rear sides of the paper P are reversed. That is, the paper P is transported in a state in which the second end E2, which has been the rear end in the transport direction so far, becomes a front end in the transport direction.

FIG. 3F shows a state in which the rotation of the reversing drum 66 has further progressed. The paper P is transported in a state of being wound on the reversing drum 66 with the second surface F2 being inwardly directed. Accordingly, the front and back surfaces of paper P are reversed.

Thus, the reversing unit 60 reverses the front and back surfaces of the paper P by reversing the front and rear sides of the paper P by performing grip switching between the front and rear sides of the paper P between the second pass drum 64 and the reversing drum 66.

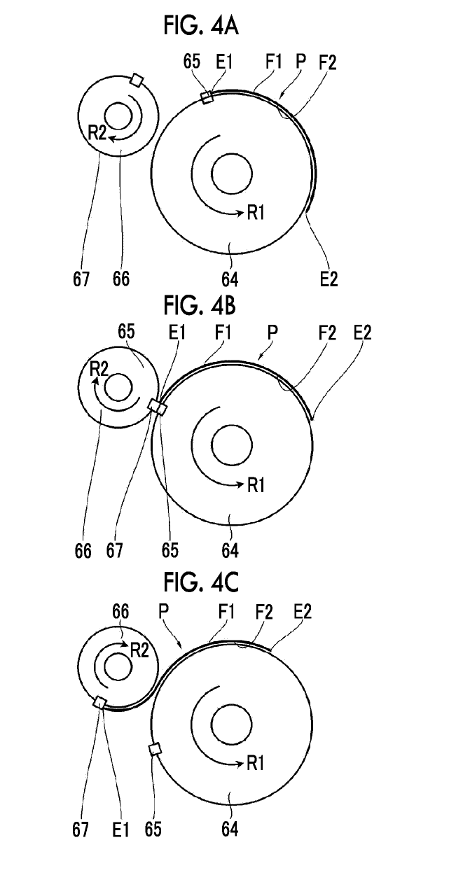

FIGS. 4A to 4C are diagrams for explaining the operation of the reversing drum when the front and back surfaces of the paper P are not reversed.

As described above, the reversing unit 60 can also transport the paper P without reversing the paper P.

FIG. 4A shows a state before passing the paper P to the reversing drum 66, that is, a state in the middle of transporting the paper P by the second pass drum 64. In this state, the paper P is transported in a state in which the first end E1, which is an end on the front side in the transport direction, is gripped by the gripper 65 of the second pass drum 64. In addition, the paper P is transported in a state in which the first surface F1 is outwardly directed.

FIG. 4B shows a state of the moment of passing the paper P from the second pass drum 64 to the reversing drum 66. Passing of the paper P is performed in a stage in which the front end (here, the first end E1) of the paper P transported by the second pass drum 64 has reached the contact point. That is, when the front end (first end E1) of the paper P transported by the second pass drum 64 reaches the contact point, the front end (first end E1) of the paper P is gripped by the reversing gripper 67 of the reversing drum 66. At the same time, the gripping of the paper P by the gripper 65 of the second pass drum 64 is released. Accordingly, the passing of the paper P is performed.

FIG. 4C shows a state after the passing of the paper P. The paper P passed to the reversing drum 66 is transported while being wound on the peripheral surface of the reversing drum 66. In this case, the paper P is transported in a state of being wound on the peripheral surface of the reversing drum 66 with the first surface F1 being inwardly directed.

Thus, when transporting the paper P without reversing the paper P, the reversing unit 60 performs grip switching of the paper P between the front ends of the paper P and transports the paper P. As a result, it is possible to transport the paper P without reversing the paper P.

### Second Processing Liquid Application Unit

The second processing liquid application unit 70 applies a predetermined processing liquid onto the second surface F2 of the paper P. The processing liquid to be applied herein is a liquid having a function of aggregating, insolubilizing, and thickening color material components of the ink used in the second printing unit 90 located in the subsequent stage.

As shown in FIG. 1, the second processing liquid application unit 70 is mainly configured to include a second processing liquid application drum 72 for transporting the paper P and a second processing liquid application device 74 for applying the processing liquid onto the second surface F2 of the paper P transported by the second processing liquid application drum 72.

The second processing liquid application drum 72 receives the paper P from the reversing drum 66 of the reversing unit 60, transports the received paper P along the predetermined transport path, and passes the paper P to the second processing liquid drying unit 80. The second processing liquid application drum 72 has a cylindrical shape, and rotates in a state in which the end of the paper P on the front side in the transport direction is gripped by a gripper 73 provided on the peripheral surface so that the paper P is transported in a state of being wound on the peripheral surface. In this case, the paper P is transported in a state of being wound on the peripheral surface of the second processing liquid application drum 72 with the second surface F2, which has not yet been printed, being outwardly directed.

The second processing liquid application device 74 applies the processing liquid onto the second surface F2 of the paper P transported by the second processing liquid application drum 72. In the present embodiment, the processing liquid is applied using a roller. The method of applying the processing liquid is not limited to this, and it is also possible to use an application method using an ink jet head, an application method using a spray, and the like.

The second processing liquid application unit 70 is configured as described above. The processing liquid is applied (pre-coated) onto the second surface F2 of the paper P while the paper P is being transported by the second processing liquid application drum 72.

### Second Processing Liquid Drying Unit

The second processing liquid drying unit 80 dries the paper P having the second surface F2 onto which the processing liquid has been applied. The second processing liquid drying unit 80 is mainly configured to include a second processing liquid drying drum 82 for transporting the paper P and a second processing liquid drying device 84 for drying the paper P by blowing warm air to the paper P transported by the second processing liquid drying drum 82.

The second processing liquid drying drum 82 receives the paper P from the second processing liquid application drum 72 of the second processing liquid application unit 70, and transports the received paper P to the second printing unit 90. The second processing liquid drying drum 82 is formed by a frame body having a cylindrical shape, and rotates in a state in which the end of the paper P on the front side in the transport direction is gripped by a gripper 83 provided on the peripheral surface so that the paper P is transported (refer to FIG. 2). In this case, the paper P is transported in a state in which the second surface F2 onto which the processing liquid has been applied is inwardly directed.

The second processing liquid drying device 84 is provided inside the second processing liquid drying drum 82, and blows warm air toward the paper P transported by the second processing liquid drying drum 82.

The second processing liquid drying unit 80 is configured as described above. The warm air is blown to the second surface F2 while the paper P is being transported by the second processing liquid drying drum 82, so that the paper P is dried.

### Second Printing Unit

The second printing unit 90 prints a color image on the second surface F2 of the paper P in the ink jet method using the ink of four colors of cyan (C), magenta (M), yellow (Y), and black (K). As shown in FIG. 1, the second printing unit 90 is mainly configured to include a second printing drum 92 for transporting the paper P, a second head unit 94 that prints a color image on the second surface F2 of the paper P by discharging ink droplets of the colors of C, M, Y, and K toward the second surface F2 of the paper P transported by the second printing drum 92, and a second scanner 98 that reads the image printed on the second surface F2 of the paper P.

The second printing drum 92 receives the paper P from the second processing liquid drying drum 82 of the second processing liquid drying unit 80, transports the received paper P along the predetermined transport path (second transport path), and passes the paper P to the second ink drying unit 100. The second printing drum 92 is an example of a second transportation unit. The second printing drum 92 has a cylindrical shape, and rotates in a state in which the end of the paper P on the front side in the transport direction is gripped by a gripper 93 provided on the peripheral surface so that the paper P is transported in a state of being wound on the peripheral surface. In this case, the paper P is transported in a state in which the second surface F2, which is the back printing surface, is wound on the peripheral surface of the second printing drum 92.

The second printing drum 92 includes a suction mechanism in order to increase the adhesion to the peripheral surface of the paper P. In the present embodiment, the paper P is adsorbed and held on the peripheral surface using negative pressure. The second printing drum 92 includes a number of suction holes on the peripheral surface, and adsorbs and holds the paper P on the peripheral surface by suction from the inside. In addition, a method of using the static electricity or the like can also be adopted as the suction mechanism.

The second head unit 94 is an example of the second printing unit, and is configured to include an ink jet head 96C for discharging ink droplets of cyan, an ink jet head 96M for discharging ink droplets of magenta, an ink jet head 96Y for discharging ink droplets of yellow, and an ink jet head 96K for discharging ink droplets of black. The ink jet heads 96C, 96M, 96Y, and 96K are disposed on the transport path (second transport path) of the paper P by the second printing drum 92.

Each of the ink jet heads 96C, 96M, 96Y, and 96K is formed by a line head that can perform printing in a single pass on the paper P transported by the second printing drum 92. Each of the ink jet heads 96C, 96M, 96Y, and 96K includes a nozzle surface in its tip portion, and discharges ink droplets toward the paper P transported by the second printing drum 92 from the nozzles disposed on the nozzle surface.

As ink, for example, aqueous ink (ink using an aqueous medium) is used. In addition, the type of ink to be used is not particularly limited, and can be appropriately selected depending on the application, purpose, or the like.

As shown in FIG. 1, the second scanner 98 is provided on the downstream side of the second head unit 94 with respect to the transport direction of the paper P by the second printing drum 92. The second scanner 98 reads the image printed on the second surface F2 of the paper P by the second head unit 94. The second scanner 98 is a line scanner, for example. The second scanner 98 is an example of a second reading unit.

The second printing unit 90 is configured as described above. Ink droplets of the colors of C, M, Y, and K from the ink jet heads 96C, 96M, 96Y, and 96K that form the second head unit 94 are ejected onto the second surface F2 of the paper P while the paper P is being transported by the second printing drum 92. As a result, a color image is printed on the second surface F2. The image printed on the second surface F2 is read by the second scanner 98 when the paper P passes through the second scanner 98.

### Second Ink Drying Unit

The second ink drying unit 100 dries the paper P immediately after the printing by the second printing unit 90. As shown in FIG. 1, the second ink drying unit 100 is mainly configured to include a second pre-drying drum 102 for transporting the paper P, a second pre-drying device 104 that pre-dries the paper P by blowing warm air to the paper P transported by the second pre-drying drum 102, a second ink drying drum 106 for transporting the paper P, and a second ink drying device 108 that dries the paper P by blowing warm air to the paper P transported by the second ink drying drum 106.

The second pre-drying drum 102 receives the paper P from the second printing drum 92 of the second printing unit 90, transports the received paper P along the predetermined transport path, and passes the paper P to the second ink drying drum 106. The second pre-drying drum 102 is formed by a frame body having a cylindrical shape, and rotates in a state in which the end of the paper P on the front side in the transport direction is gripped by a gripper 103 provided on the peripheral surface so that the paper P is transported. In this case, the paper P is transported in a state in which the printed second surface F2 is inwardly directed.

The second pre-drying device 104 is provided inside the second pre-drying drum 102, and blows warm air toward the paper P transported by the second pre-drying drum 102.

The second ink drying drum 106 receives the paper P from the second pre-drying drum 102, transports the received paper P along the predetermined transport path, and passes the paper P to the stacking unit 110. The second ink drying drum 106 has a cylindrical shape, and rotates in a state in which the end of the paper P on the front side in the transport direction is gripped by a gripper 55 provided on the peripheral surface so that the paper P is transported in a state of being wound on the peripheral surface. In this case, the paper P is transported in a state in which the printed second surface F2 is outwardly directed.

The second ink drying device 108 is provided on the transport path of the paper P by the second ink drying drum 106, and blows warm air toward the paper P transported by the second ink drying drum 106.

The second ink drying unit 100 is configured as described above. The paper P is transported while being passed from the second pre-drying drum 102 to the second ink drying drum 106, and is dried by warm air blown to the second surface F2 in the transport process.

### Stacking Unit

The stacking unit 110 stacks the printed paper P in one place. As shown in FIG. 1, the stacking unit 110 is mainly configured to include a chain gripper for stacking 112 for transporting the paper P and an stacking device 114 that receives and stacks the paper P transported by the chain gripper for stacking 112.

The chain gripper for stacking 112 is configured to include a pair of endless chains disposed along the transport path of the paper P and a plurality of grippers disposed at fixed distances in the chain. The chain gripper for stacking 112 receives the paper P from the second ink drying drum 106, and transports the received paper P along the predetermined transport path. The chain gripper for stacking 112 releases the paper P at a predetermined stacking position to pass the paper P to the stacking device 114.

The stacking device 114 receives the paper P released at the predetermined stacking position from the chain gripper for stacking 112, and stacks the paper P in a bundle.

### Explanation of a Control System

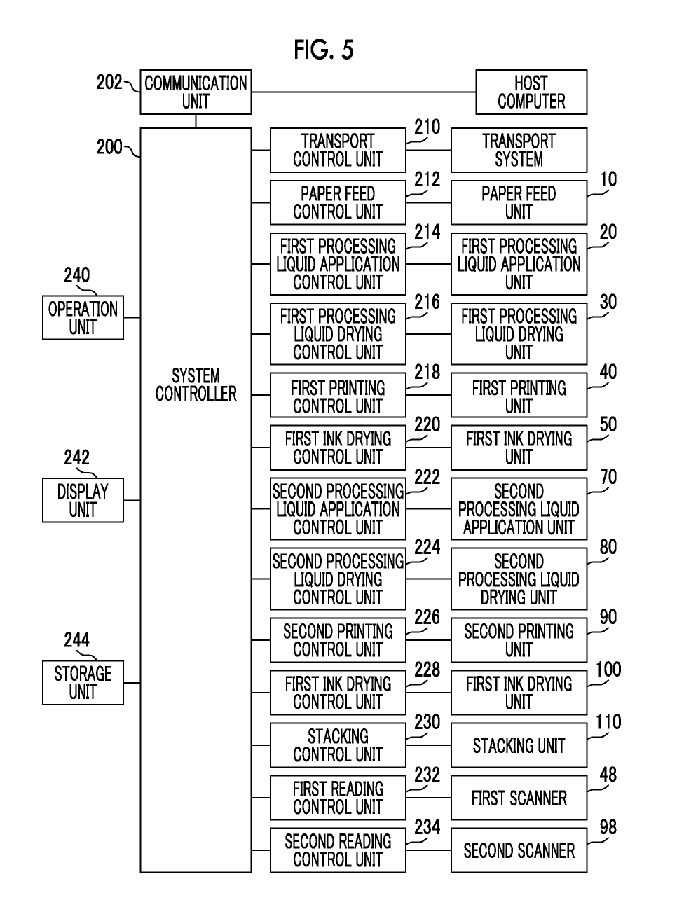

FIG. 5 is a block diagram showing the schematic configuration of a control system of the double-sided printing apparatus 1.

As shown in FIG. 5, in the double-sided printing apparatus 1, a system controller 200, a communication unit 202, a transport control unit 210, a paper feed control unit 212, a first processing liquid application control unit 214, a first processing liquid drying control unit 216, a first printing control unit 218, a first ink drying control unit 220, a second processing liquid application control unit 222, a second processing liquid drying control unit 224, a second printing control unit 226, a second ink drying control unit 228, a stacking control unit 230, a first reading control unit 232, a second reading control unit 234, an operating unit 240, a display unit 242, and a storage unit 244 are provided as a control system.

The system controller 200 functions as a control unit that performs overall control of the double-sided printing apparatus 1. For example, the system controller 200 is a microcomputer including a central processing unit (CPU), a read only memory (ROM), a random access memory (RAM: random access readable and writable memory), and the like. The system controller 200 functions as a control unit by executing a predetermined control program.

The system controller 200 functions as a print layout setting unit, an image processing unit, a checking unit, and the like by executing predetermined programs. Programs executed by the system controller 200 are stored in the ROM or the storage device of the storage unit 244.

The communication unit 202 transmits and receives data to and from an external device connected to the double-sided printing apparatus 1 under the control of the system controller 200. The communication unit 202 has a required communication interface. The double-sided printing apparatus 1 is communicably connected to an external device, such as a host computer, through the communication interface. A print job is received through the communication unit 202.

The transport control unit 210 controls the transport of the paper P in response to the instruction from the system controller 200. Specifically, the transport control unit 210 controls the driving of the transport system of the paper P. The transport system of the paper P is configured to include the feed drum 16 of the paper feed unit 10, the first processing liquid application drum 22 of the first processing liquid application unit 20, the first processing liquid drying drum 32 of the first processing liquid drying unit 30, the first printing drum 42 of the first printing unit 40, the first pre-drying drum 52 and the first ink drying drum 56 of the first ink drying unit 50, the first pass drum 62, the second pass drum 64, and the reversing drum 66 of the reversing unit 60, the second processing liquid application drum 72 of the second processing liquid application unit 70, the second processing liquid drying drum 82 of the second processing liquid drying unit 80, the second printing drum 92 of the second printing unit 90, the second pre-drying drum 102 and the second ink drying drum 106 of the second ink drying unit 100, and the chain gripper for stacking 112 of the stacking unit 110. The transport control unit 210 controls the transport of the paper P by controlling each unit of the transport system in response to the instruction from the system controller 200. In addition, control of the reversal of the paper P is also included in the control of the transport of the paper P performed by the transport control unit 210.

The paper feed control unit 212 controls the feeding of the paper P by controlling the driving of each unit (excluding the units of the transport system) of the paper feed unit 10 in response to the instruction from the system controller 200. For example, the paper feed control unit 212 controls the driving of the paper feeder 12 and the feeder board 14 so that the paper P is fed at the designated paper feed speed.

The first processing liquid application control unit 214 controls the application of the processing liquid onto the paper P by controlling the driving of each unit (excluding the units of the transport system) of the first processing liquid application unit 20 in response to the instruction from the system controller 200. For example, the first processing liquid application control unit 214 controls the driving of the first processing liquid application device 24 so that the processing liquid is applied onto the paper P in the designated range and thickness.

The first processing liquid drying control unit 216 controls the drying of the paper P after the application of the processing liquid by controlling the driving of each unit (excluding the units of the transport system) of the first processing liquid drying unit 30 in response to the instruction from the system controller 200. For example, the first processing liquid drying control unit 216 controls the driving of the first processing liquid application device 24 so that the paper P is dried with the designated drying strength.

The first printing control unit 218 controls printing on the paper P by controlling the driving of each unit (excluding the units of the transport system and the first scanner 48) of the first printing unit in response to the instruction from the system controller 200. For example, the first printing control unit 218 controls the driving of the ink jet heads 46C, 46M, 46Y, and 46K so that the designated image is printed.

The first ink drying control unit 220 controls the drying of the paper P after printing of the first surface by controlling the driving of each unit (excluding the units of the transport system) of the first ink drying unit 50 in response to the instruction from the system controller 200. For example, the first ink drying control unit 220 controls the driving of the first pre-drying device 54 and the first ink drying device 58 so that the paper P is dried with the designated drying strength.

The second processing liquid application control unit 222 controls the application of the processing liquid onto the paper P by controlling the driving of each unit (excluding the units of the transport system) of the second processing liquid application unit 70 in response to the instruction from the system controller 200. For example, the second processing liquid application control unit 222 controls the driving of the second processing liquid application device 74 so that the processing liquid is applied onto the paper P in the designated range and thickness.

The second processing liquid drying control unit 224 controls the drying of the paper P after the application of the processing liquid by controlling the driving of each unit (excluding the units of the transport system) of the second processing liquid drying unit 80 in response to the instruction from the system controller 200. For example, the second processing liquid drying control unit 224 controls the driving of the second processing liquid drying device 84 so that the paper P is dried with the designated drying strength.

The second printing control unit 226 controls printing on the paper P by controlling the driving of each unit (excluding the units of the transport system and the second scanner 98) of the second printing unit in response to the instruction from the system controller 200. For example, the second printing control unit 226 controls the driving of the ink jet heads 96C, 96M, 96Y, and 96K so that the designated image is printed.

The second ink drying control unit 228 controls the drying of the paper P after printing of the second surface by controlling the driving of each unit (excluding the units of the transport system) of the second ink drying unit 100 in response to the instruction from the system controller 200. For example, the second ink drying control unit 228 controls the driving of the second pre-drying device 104 and the second ink drying device 108 so that the paper P is dried with the designated drying strength.

The stacking control unit 230 controls the stacking of the paper P after printing is completed by controlling the driving of each unit (excluding the units of the transport system) of the stacking unit 110 in response to the instruction from the system controller 200. That is, the stacking control unit 230 controls the driving of the stacking device 114 so that the sequentially discharged paper P is stacked in a bundle.

The first reading control unit 232 controls the driving of the first scanner 48 in response to the instruction from the system controller 200, and controls the reading of the image printed on the first surface F1 and the output of the read image data.

The second reading control unit 234 controls the driving of the second scanner 98 in response to the instruction from the system controller 200, and controls the reading of the image printed on the second surface F2 and the output of the read image data.

The operating unit 240 includes operation devices, such as an operation button, a keyboard, and a touch panel. The operating unit 240 outputs the operation information of these operation devices to the system controller 200. The system controller 200 performs various kinds of processing according to the operation information output from the operating unit 240.

The display unit 242 includes a display device, such as a liquid crystal panel. The display unit 242 displays various kinds of information on a display device in response to the instruction from the system controller 200.

The storage unit 244 includes a nonvolatile storage device. The storage unit 244 reads and writes various kinds of information from and into a storage device in response to the instruction from the system controller 200.

### Print Layout Setting Unit

As described above, the system controller 200 functions as a print layout setting unit by executing a predetermined program (print layout setting program). The print layout setting unit sets the layouts of images to be actually printed on the first and second surfaces F1 and F2 of the paper P. The images to be actually printed on the first and second surfaces F1 and F2 of the paper P include a print target image and a test image.

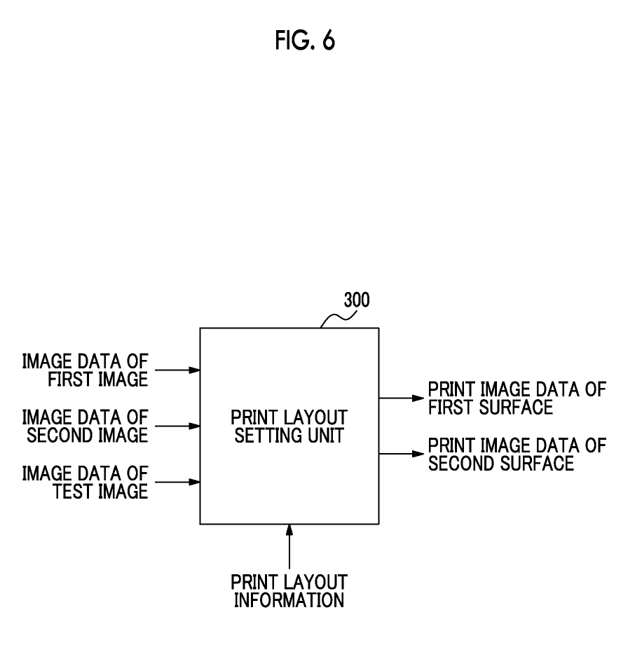

FIG. 6 is a functional block diagram of the print layout setting unit realized by the system controller. As shown in FIG. 6, the print layout setting unit 300 acquires image data of an image (first image) printed on the first surface F1 of the paper P, image data of an image (second image) printed on the second surface F2 of the paper P, and image data of the test image, and determines the print layout of the first surface F1 of the paper P and the print layout of the second surface F2 of the paper P based on the print layout information. Then, according to the determined print layout, image data of an image to be actually printed on the first surface F1 (print image data of the first surface) of the paper P and image data of an image to be actually printed on the second surface F2 (print image data of the second surface) of the paper P are generated.

The image data of the first image, which is an image to be printed on the first surface F1 of the paper P, and the image data of the second image, which is an image to be printed on the second surface F2 of the paper P, are image data of the print target image, and are acquired from the print job. That is, since the image data information of images (first and second images) that the user desires to print is included in the print job, the print layout setting unit 300 acquires the information of the image data of the first and second images from the print job.

The image data of the test image is acquired from the storage unit 244. The image data of the test image is stored in advance in the storage unit 244.

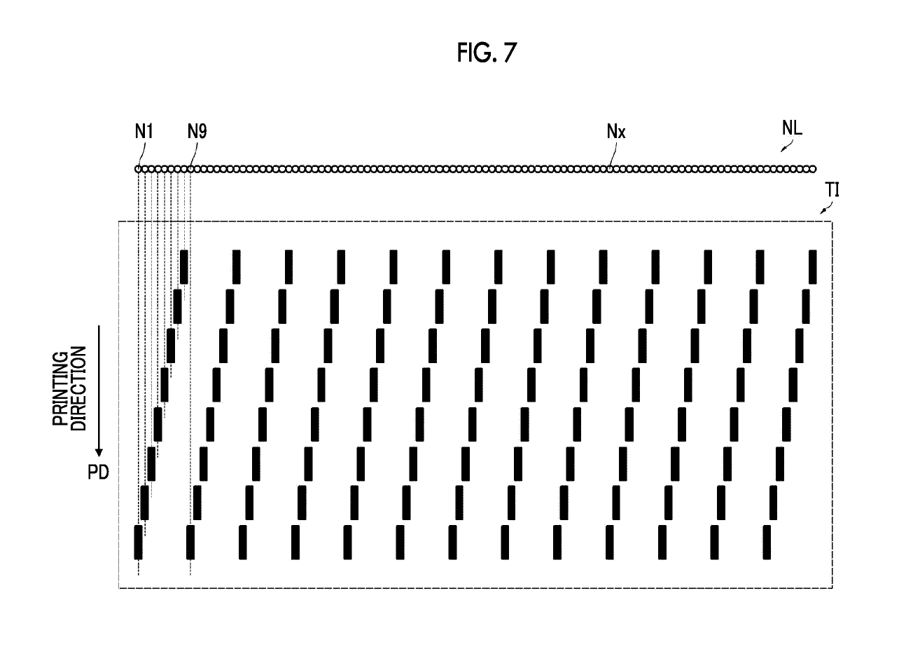

FIG. 7 is a diagram showing an example of the test image. A test image TI shown in FIG. 7 is a so-called one-ON-n-OFF type test image for nozzle check (test chart) TI that is formed in a predetermined line pattern. By using the test image TI, it is possible to check the presence or absence of a discharge failure nozzle (nozzle in a non-discharging state) and the presence or absence of a discharge direction failure nozzle (nozzle in which discharge direction failure (so-called discharge bend) has occurred). In addition, in the example shown in FIG. 7, 1-ON-7-OFF type test image TI is shown. In the 1-ON-7-OFF type, a nozzle line NL is divided into eight groups each including seven nozzles, and discharging is performed in order in units of a group. Specifically, nozzles are numbered according to the arrangement of the nozzle line NL (Nx (x=1, 2, . . . )). Nozzle numbers N1, N9, N17, . . . are grouped into a first group, nozzle numbers N2, N10, N18, . . . are grouped into a second group, nozzle numbers N3, N11, N19, . . . are grouped into a third group, nozzle numbers N4, N12, N20, . . . are grouped into a fourth group, nozzle numbers N5, N13, N21, . . . are grouped into a fifth group, nozzle numbers N6, N14, N22, . . . are grouped into a sixth group, nozzle numbers N7, N15, N23, . . . are grouped into a seventh group, and nozzle numbers N8, N16, N24, . . . are grouped into an eighth group. Discharging is performed in order from the first group in units of a group. One vertical line segment (line) is drawn by one nozzle, thereby drawing the pattern of all nozzles.

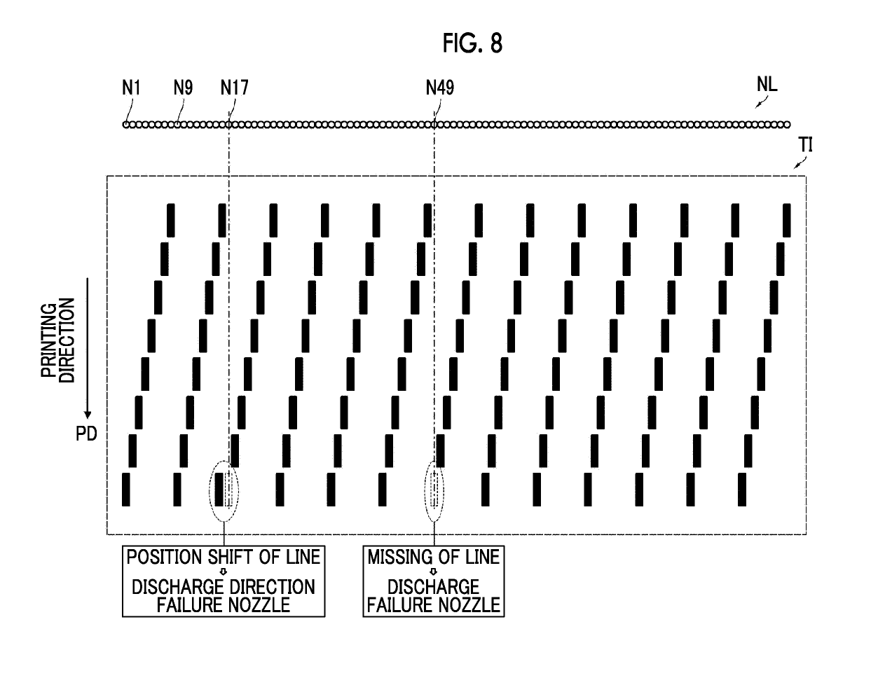

FIG. 8 is a conceptual diagram of the detection of a discharge failure nozzle and a discharge direction failure nozzle using the test image shown in FIG. 7. As shown in FIG. 8, in the case of a discharge failure nozzle, the relevant line is missing. In the case of a discharge direction failure nozzle, the position of the relevant line is shifted from the normal position. Therefore, it is possible to detect a discharge failure nozzle and a discharge direction failure nozzle by reading the drawn (printed) test image TI and detecting a missing line and a line, which is shifted from the normal position, from the read image. In the example shown in FIG. 8, in the nozzle of the nozzle number N49, missing of the relevant line is observed. Accordingly, the nozzle of the nozzle number N49 can be detected as a discharge failure nozzle. In addition, in the nozzle of the nozzle number N17, a positional shift is observed in the relevant line. Accordingly, the nozzle of the nozzle number N17 can be detected as a discharge direction failure nozzle.

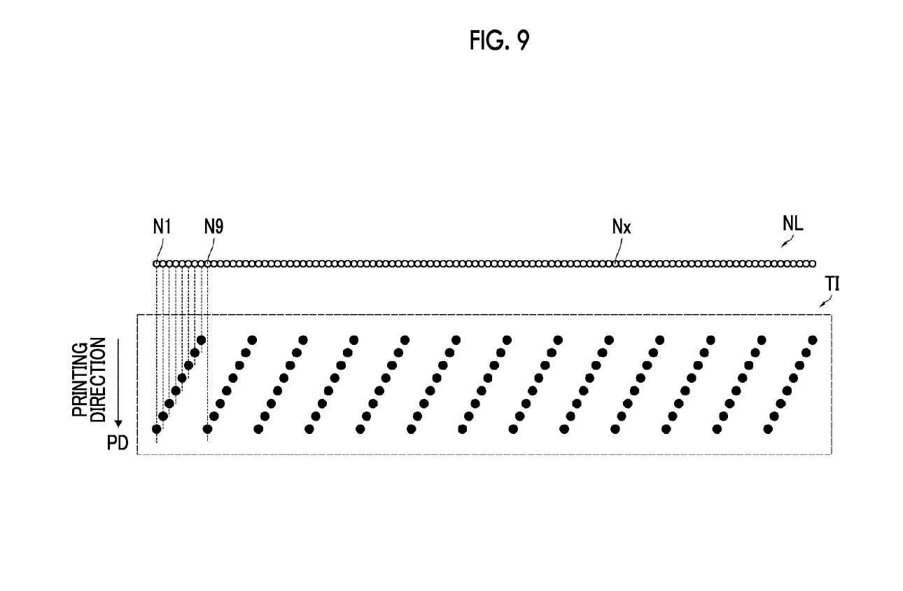

FIG. 9 is a diagram showing another example of the test image. The test image TI shown in FIG. 9 is a test image TI formed of dots. Similar to the one-ON-n-OFF type test image for nozzle check TI shown in FIG. 7, the test image TI is also formed by dividing the nozzle line NL into a plurality of groups each including a predetermined number of nozzles and performing discharging in order in units of a group. In the example shown in FIG. 9, the test image TI having a predetermined dot pattern is printed by dividing the nozzle line NL into eight groups each including seven nozzles and performing discharging in order in units of a group. Also in the test image TI formed in the dot pattern, similar to the test image TI formed in the line pattern shown in FIG. 7, it is possible to check the presence or absence of a discharge failure nozzle and the presence or absence of a discharge direction failure nozzle.

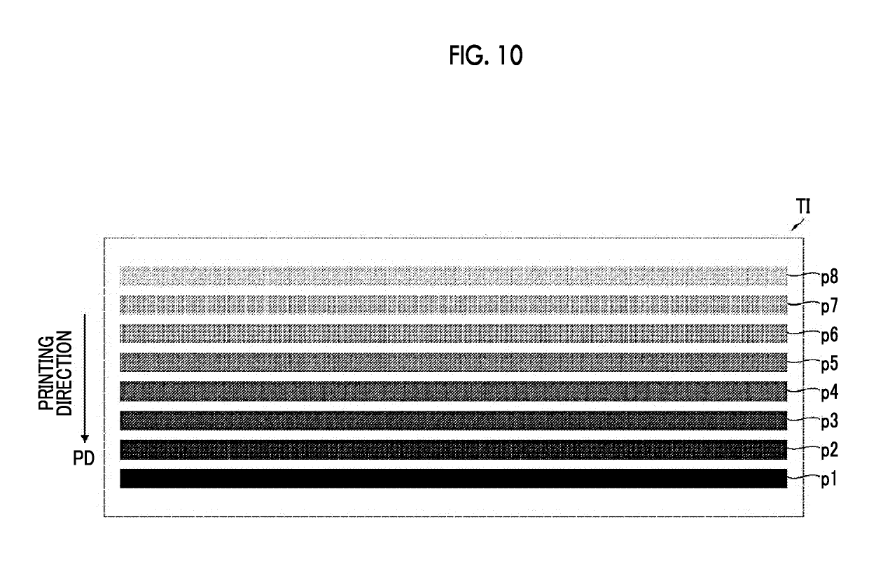

FIG. 10 is a diagram showing still another example of the test image. The test image TI is a test image for density measurement with a predetermined patch pattern, and is formed by arranging strip-shaped density patches p1 to p8, each of which has a fixed width, at fixed distances therebetween in a printing direction PD. A gradation value (density) is set for each of the density patches p1 to p8, and the density patches p1 to p8 are printed according to the set gradation value. By printing the test image TI for density measurement, it is possible to check the presence or absence of density unevenness, for example.

The print layout information is information for determining the print layouts of the first and second surfaces F1 and F2 of the paper P, and includes information of a gripping region of the paper P and information of a position where the test image is printed.

Here, the information of the gripping region of the paper P is information of a region where the paper P is gripped by the gripping unit at the time of printing. In the double-sided printing apparatus 1 of the present embodiment, the paper P is transported in a state in which the end of the paper P on the front side in the transport direction is gripped. The gripping region is set as a region gripped by the gripper 43 of the first printing drum 42 and a region gripped by the gripper 93 of the second printing drum 92, and is set at the end of the paper P as a strip-shaped region having a fixed width (set at the end of only one side at the time of single-sided printing, and set at the ends of both sides at the time of double-sided printing).

Since the gripping region is a region gripped by the gripper, a region from the end of the paper P to the tip portion of the gripper (tip portion of the gripping claw) is the gripping region. However, since the paper P is deformed by gripping using a gripper, it is preferable to set the gripping region in consideration of the deformation of the paper P due to the gripping. That is, it is preferable to set the gripping region by securing a predetermined margin.

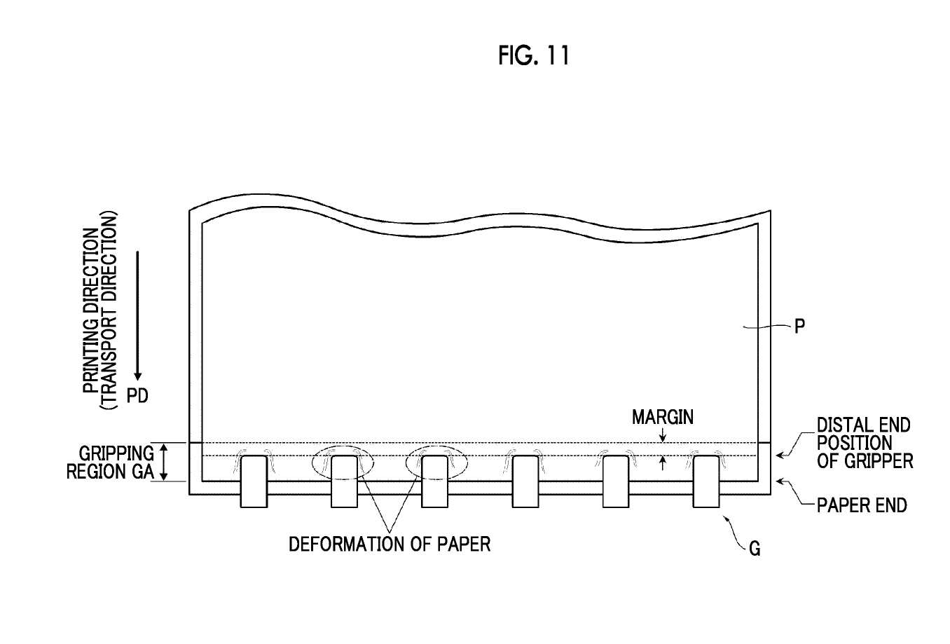

FIG. 11 is a conceptual diagram of the setting of a gripping region. As shown in FIG. 11, the paper P is deformed by gripping using a gripper G (for example, grip marks, wrinkles, or the like occur in a gripped portion). In addition, a variation in the gripping amount (amount gripped by the gripping claw) may occur due to grip switching. Therefore, it is preferable to set a gripping region GA in consideration of the deformation of the paper P and the variation in the gripping amount at the time of gripping.

The information of the position where the test image is printed is information of a position where the test image is printed in a sheet of paper. At the time of double-sided printing, the position where the test image is printed is set at the same position on the front and back surfaces of the paper P, that is, on the first and second surfaces F1 and F2. In other words, the position where the test image is printed is set such that the test image is disposed at positions overlapping each other when the paper P is seen therethrough from one surface side of the paper P.

At the time of double-sided printing, the print layout setting unit 300 determines the print layout of the first surface F1 of the paper P and the print layout of the second surface F2 of the paper P based on the print layout information, and generates image data (print image data) of print images to be actually printed on the first and second surfaces F1 and F2 of the paper P.

At the time of single-sided printing, the print layout setting unit 300 acquires image data of an image (first image) to be printed on the first surface F1 of the paper P and image data of the test image, determines the print layout of the first surface F1 of the paper P based on the print layout information, and generates image data of an image to be actually printed on the first surface F1 of the paper P according to the determined print layout.

The image to be actually printed on the paper P is an image including a print target image (first and second images) and a test image, and an image in which these images are disposed in a predetermined layout is a print image.

The process of setting the print layout will be further described in detail later.

### Image Processing Unit

As described above, the system controller 200 functions as an image processing unit by the execution of a predetermined program (image processing program).

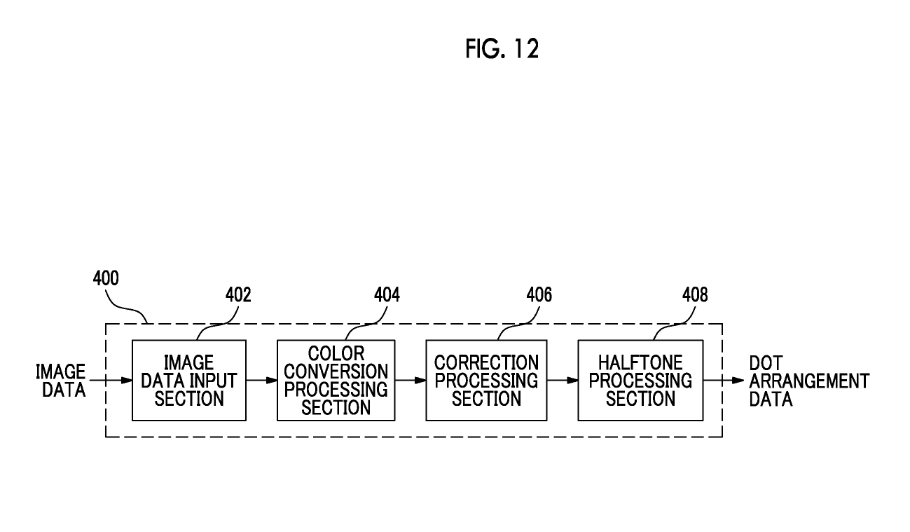

FIG. 12 is a functional block diagram of the image processing unit realized by the system controller. As shown in FIG. 12, an image processing unit 400 includes an image data input section 402, a color conversion processing section 404, a correction processing section 406, and a halftone processing section 408.

The image data input section 402 acquires image data of an image to be actually printed. Here, print image data to be printed on the first surface F1 (print image data of the first surface) of the paper P and print image data to be printed on the second surface F2 (print image data of the second surface) of the paper P are acquired.

The color conversion processing section 404 performs processing for converting the image data input from the image data input section 402 into ink amount data of each color. In the present embodiment, since a color image is printed using the ink of four colors of cyan, magenta, yellow, and black, the image data input from the image data input section 402 is converted into ink amount data of each color of cyan, magenta, yellow, and black. Information required for processing is stored in the storage unit 244.

The correction processing section 406 performs predetermined correction processing on the ink amount data of each color when necessary. For example, density unevenness correction to correct the variation in the recording characteristics of nozzles in each head is performed. Information required for processing is stored in the storage unit 244.

The halftone processing section 408 generates dot arrangement data converted into ON/OFF data of dots by binarizing the ink amount data in each location. Information required for processing is stored in the storage unit 244.

The image processing unit 400 is configured as described above. The image data is converted into the ink amount data of each color by the color conversion processing section 404, and is then subjected to correction processing by the correction processing section 406 when necessary. Thereafter, halftone processing is performed by the halftone processing section 408, so that the image data after the correction processing is converted into dot arrangement data of each color.

The first printing control unit 218 and the second printing control unit 226 print an image on the paper P by driving each ink jet head based on the dot arrangement data of each color generated by the image processing unit 400.

### Operation of a Double-Sided Printing Apparatus

### Overview of Single-Sided Printing and Double-Sided Printing

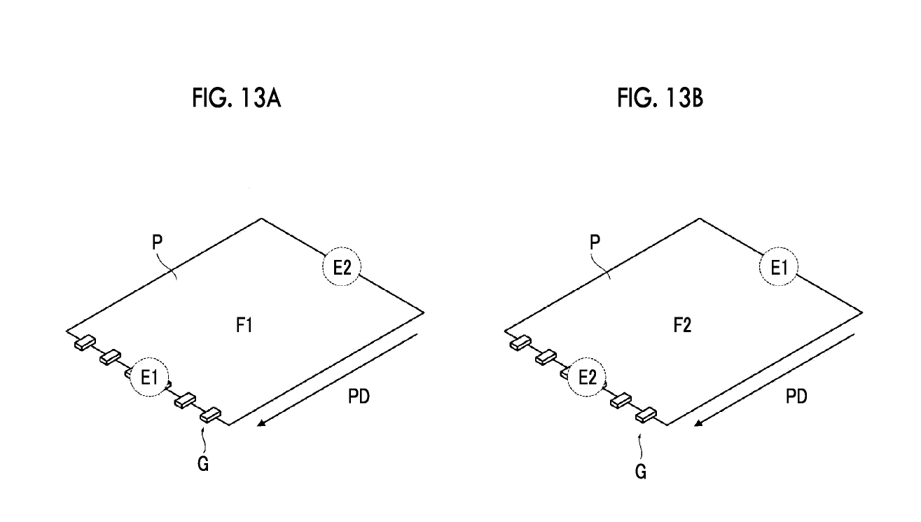

The double-sided printing apparatus 1 of the present embodiment can perform single-sided printing and double-sided printing. At the time of single-sided printing, an image is printed on only the first surface F1 of the paper P. At the time of double-sided printing, images are printed on the first and second surfaces F1 and F2 of the paper P. At the time of double-sided printing, the front and back surfaces of the paper P are reversed after the printing of the first surface F1. At the time of reversing, the front and back surfaces of the paper P are reversed by performing grip switching between the front and rear sides of the paper P. Accordingly, at the time of printing of the first surface F1 and printing of the second surface F2, the front and rear relationship of the ends with respect to the transport direction of the paper P is reversed. This point will be described with reference to FIGS. 13A and 13B.

FIGS. 13A and 13B are conceptual diagrams of the paper transport form at the time of double-sided printing. FIG. 13A shows the paper transport form at the time of printing of the first surface, and FIG. 13B shows the paper transport form at the time of printing of the second surface.

One surface that is the front printing surface of the paper P is set to the first surface F1, and the other surface that is the back printing surface is set to the second surface F2. For the first surface F1 of the paper P, the end of the first surface F1 on the front side in a printing direction (transport direction) PD is a first end E1 of the paper P, and the end on the rear side is a second end E2.

As shown in FIG. 13A, at the time of printing of the first surface F1, the first end E1 of the paper P is located on the front side in the printing direction (transport direction), and the paper P is transported in a state in which the first end E1 is gripped by the gripper G.

On the other hand, at the time of printing of the second surface F2, as shown in FIG. 13B, the second end E2 of the paper P is located on the front side in the printing direction (transport direction), and the paper P is transported in a state in which the second end E2 is gripped by the gripper G.

### Flow of the Printing Process at the Time of Double-Sided Printing

The process of double-sided printing is performed in order of (a) paper feed, (b) application of the processing liquid onto the first surface, (c) drying of the processing liquid applied onto the first surface, (d) printing on the first surface (first surface printing step), (e) reading of the test image printed on the first surface, (f) drying of ink, (g) reversing of the front and back surfaces of paper, (h) application of the processing liquid onto the second surface, (i) drying of the processing liquid applied to the second surface, (j) printing on the second surface (second surface printing step), (k) reading of the test image printed on the second surface, (l) drying of ink, and (m) stacking.

When a print job is received, the double-sided printing apparatus reads image data of a print target image included in the print job, and sets the print layout. Then, image data of an image to be actually printed is generated, and dot arrangement data for printing in the first printing unit 40 and the second printing unit 90 is generated from the generated image data. After generating the dot arrangement data, printing is started according to the content designated by the print job.

When the printing is started, paper feeding is started from the paper feed unit 10. The paper P fed from the paper feed unit 10 is first transported to the first processing liquid application unit 20, so that the processing liquid is applied onto the first surface F1 by the first processing liquid application unit 20. Then, the paper P having the first surface F1 onto which the processing liquid has been applied is transported to the first processing liquid drying unit 30. Then, drying processing is performed by the first processing liquid drying unit 30. Then, the dried paper P is transported to the first printing unit 40. Then, an image is printed on the first surface F1 by the first printing unit 40 (first surface printing step). In this case, the paper P is transported in a state in which the first end E1 is gripped. Then, for the paper P having the first surface F1 on which the image is printed, the test image printed on the first surface F1 is read by the first printing unit 40. The reading is performed by the first scanner 48 provided in the first printing unit 40, and is performed immediately after printing. Then, the paper P from which the test image has been read is transported to the first ink drying unit 50. Then, drying processing is performed by the first ink drying unit 50. Then, the dried paper P is transported to the reversing unit 60. Then, the front and back surfaces of the paper P are reversed by the reversing unit 60. In this case, the front and back surfaces of the paper P are reversed by reversing the front and rear ends in the transport direction. Then, the paper P after reversing the front and back surfaces is transported to the second processing liquid application unit 70. Then, the processing liquid is applied onto the second surface F2 by the second processing liquid application unit 70. Then, the paper P having the second surface F2 onto which the processing liquid has been applied is transported to the second processing liquid drying unit 80. Then, drying processing is performed by the second processing liquid drying unit 80. Then, the dried paper P is transported to the second printing unit 90. Then, an image is printed on the second surface F2 by the second printing unit 90 (second surface printing step). In this case, the paper P is transported in a state in which the second end E2 is gripped. Then, for the paper P having the second surface F2 on which the image is printed, the test image printed on the second surface F2 is read by the second printing unit 90. The reading is performed by the second scanner 98 provided in the second printing unit 90, and is performed immediately after printing. Then, the paper P from which the test image has been read is transported to the second ink drying unit 100. Then, drying processing is performed by the second ink drying unit 100. The dried paper P is transported to the stacking unit 110, and is stacked on the stacking device 114 of the stacking unit 110.

Thus, at the time of double-sided printing, the front and back surfaces of the paper P are reversed en route so that images are printed on both surfaces of the paper P.

In addition, when a discharge failure nozzle or a discharge defective nozzle is detected during the printing process, discharge failure correction is performed when necessary. When the problem cannot be solved even if the discharge failure correction is performed, the operation of the apparatus is stopped and maintenance or the like is performed.

### Flow of the Printing Process at the Time of Single-Sided Printing

The process of single-sided printing is performed in order of (a) paper feed, (b) application of the processing liquid onto the first surface, (c) drying of the processing liquid applied onto the first surface, (d) printing on the first surface, (e) reading of the test image printed on the first surface, (f) drying of ink, and (g) stacking.

When a print job is received, the double-sided printing apparatus reads image data of a print target image included in the print job, and sets the print layout. Then, image data of an image to be actually printed is generated, and dot arrangement data for printing in the first printing unit 40 is generated from the generated image data. After generating the dot arrangement data, printing is started according to the content designated by the print job.

When the printing is started, paper feeding is started from the paper feed unit 10. The paper P fed from the paper feed unit 10 is first transported to the first processing liquid application unit 20, so that the processing liquid is applied onto the first surface F1 by the first processing liquid application unit 20. Then, the paper P having the first surface F1 onto which the processing liquid has been applied is transported to the first processing liquid drying unit 30. Then, drying processing is performed by the first processing liquid drying unit 30. Then, the dried paper P is transported to the first printing unit 40. Then, the image is printed on the first surface F1 by the first printing unit 40. Then, for the paper P having the first surface F1 on which the image is printed, the test image printed on the first surface F1 is read by the first printing unit 40. The reading of the test image is performed by the first scanner 48 provided in the first printing unit 40, and is performed immediately after printing. Then, the paper P from which the test image has been read is transported to the first ink drying unit 50. Then, drying processing is performed by the first ink drying unit 50. The dried paper P is transported to the stacking unit 110 after passing through the reversing unit 60, the second processing liquid application unit 70, the second processing liquid drying unit 80, the second printing unit 90, and the second ink drying unit 100, and is stacked on the stacking device 114 of the stacking unit 110. That is, the dried paper P is transported without any processing being performed in the reversing unit 60, the second processing liquid application unit 70, the second processing liquid drying unit 80, the second printing unit 90, and the second ink drying unit 100. In addition, since the reversal processing in the reversing unit 60 is not performed, the paper P is transported in a state in which the first end E1 is always located on the front side in the transport direction.

Thus, at the time of single-sided printing, printing is performed only by the first printing unit 40 without reversing the paper P.

In addition, when a discharge failure nozzle or a discharge defective nozzle is detected during the printing process, discharge failure correction is performed when necessary. When the problem cannot be solved even if the discharge failure correction is performed, the operation of the apparatus is stopped and maintenance or the like is performed.

### Printing Layout Setting Method

As described above, the double-sided printing apparatus 1 of the present embodiment prints a test image together with a print target image at the time of printing. That is, images to be actually printed by the double-sided printing apparatus 1 of the present embodiment include a print target image and a test image. At which positions of the paper P the print target image and the test image are to be printed, that is, in which layout the print target image and the test image are to be printed, is set by the print layout setting unit 300 according to a rule set in advance. Hereinafter, the layout method of the print target image and the test image will be described.

### At the Time of Single-Sided Printing

At the time of single-sided printing, images are printed on the first surface F1 of the paper P in a state in which the first end E1 is gripped throughout.

The print layout setting unit 300 acquires the print layout information stored in the storage unit 244, acquires the information of the gripping region GA, and sets the gripping region GA of the paper P at the first end E1 of the first surface F1 of the paper P. Then, a region other than the gripping region (region excluding the gripping region GA from the entire first surface F1 of the paper P) is set as a first surface printable region PA1, and a first image printing region IA1 for printing a first image and a first test image printing region TA1 for printing a test image are set within the range of the set first surface printable region PA1.

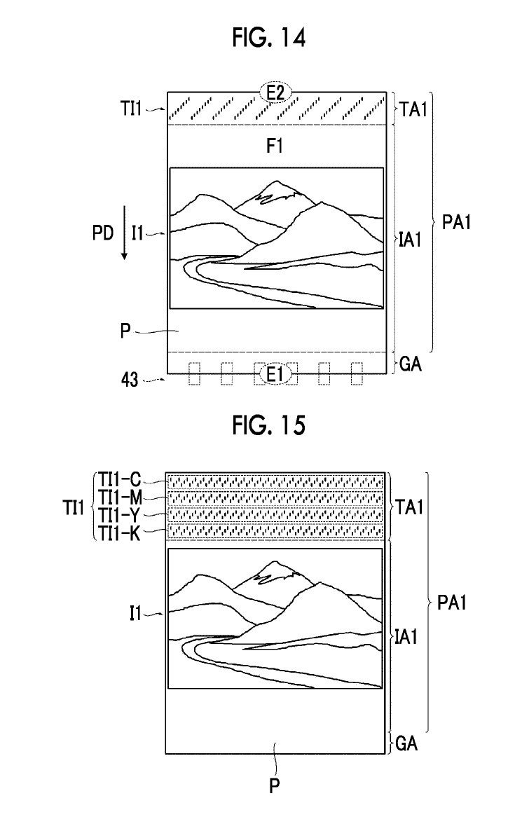

FIG. 14 is a conceptual diagram of the setting of the print layout at the time of single-sided printing.

As shown in FIG. 14, the gripping region GA is set as a strip-shaped region having a fixed width, and a region excluding the gripping region GA is set as the first surface printable region PA1. That is, a region after the rear end of the gripping region GA in the printing direction PD of the paper P is set as the first surface printable region PA1. The first surface printable region PA1 is set as a region that is not influenced by the deformation of the paper P due to gripping.

The first image printing region IA1 for printing a first image I1 that is a print target image with respect to the first surface F1 and the first test image printing region TA1 for printing a first test image TI1 that is a test image with respect to the first surface F1 are set within the first surface printable region PA1. The print layout setting unit 300 acquires position information for setting the first test image printing region TA1 from the print layout information, and sets the first image printing region IA1 and the first test image printing region TA1 within the first surface printable region PA1.

Here, the first test image printing region TA1 is set as a region (strip-shaped region having a fixed width) crossing the paper P in a direction perpendicular to the printing direction PD. In addition, in this example, the first test image printing region TA1 is set in a rear end portion of the first surface printable region PA1 in the printing direction PD. In addition, in this example, since the rear end of the first surface printable region PA1 in the printing direction PD matches the rear end of the paper P in the printing direction PD, the first test image printing region TA1 is set in a rear end portion of the paper P in the printing direction PD.

The first test image TI1 is printed in the first test image printing region TA1. The first test image TI1 may be configured to check all of ink jet heads (in this example, four ink jet heads of CMYK) provided in the printing unit at once, or may be configured to check the ink jet heads provided in the printing unit separately.

FIG. 15 is a diagram showing an example of the test image when checking all of ink jet heads provided in the printing unit at once.

As shown in FIG. 15, when checking all of the ink jet heads (in this example, four ink jet heads of CMYK) provided in the printing unit at once, an image obtained by combining a test image TI1-C for the cyan ink jet head, a test image TI1-M for the magenta ink jet head, a test image TI1-Y for the yellow ink jet head, and a test image TI1-K for the black ink jet head is formed as a test image TI1 to be printed in the first test image printing region TA1.

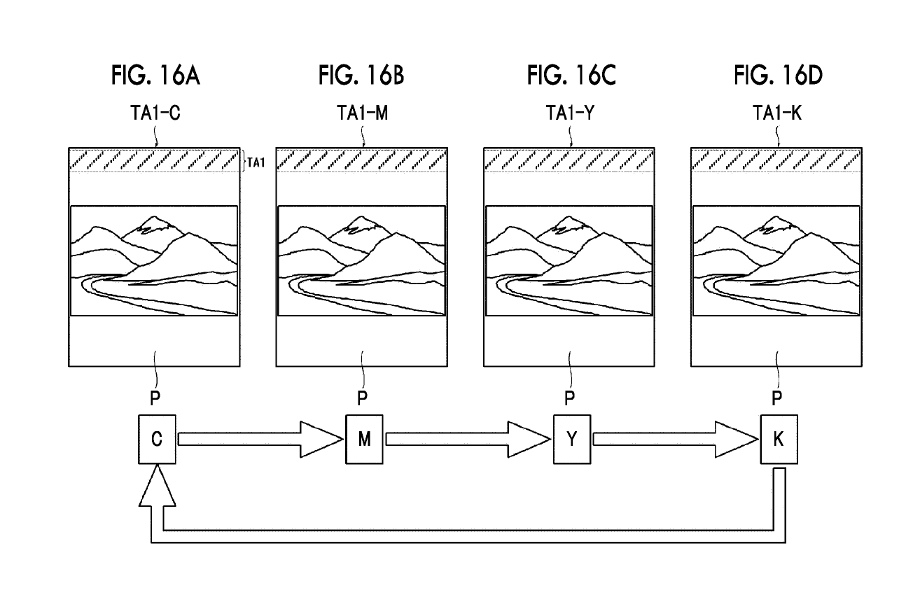

FIGS. 16A to 16D are diagrams showing an example of the test image when checking ink jet heads provided in the printing unit separately.

As shown in FIGS. 16A to 16D, when checking the ink jet heads provided in the printing unit separately, the ink jet head to be checked is switched for each sheet of paper. That is, test images of the respective ink jet heads are printed in order. In the example shown in FIGS. 16A to 16D, the respective ink jet heads are checked in order of cyan, magenta, yellow, and black. In this case, in the first test image printing region TA1, test images of the respective ink jet heads are printed in order.

The first image printing region IA1 is set as a region excluding the first test image printing region TA1 from the first surface printable region PA1. In this example, the gripping region GA is set at the front end in the printing direction PD, and the first test image printing region TA1 is set at the rear end. Accordingly, a region between the gripping region GA and the first test image printing region TA1 is set as the first image printing region IA1. The first image I1 that is a print target image on the first surface F1 is printed in the first image printing region IA1.

Thus, at the time of single-sided printing, the gripping region GA is set at the front end of the paper P in the printing direction PD, the first test image printing region TA1 is set at the rear end, and the first image printing region IA1 is set between the gripping region GA and the first test image printing region TA1. The print layout setting unit 300 generates a print image by arranging the test image in the first test image printing region TA1 and the first image in the first image printing region IA1.

### At the Time of Double-Sided Printing

At the time of double-sided printing, both ends of the paper P are gripped. That is, the first end E1 is gripped at the time of printing of the first surface F1, and the second end E2 is gripped at the time of printing of the second surface F2.

The print layout setting unit 300 acquires the print layout information stored in the storage unit 244, acquires the information of the gripping region GA, and sets the gripping region GA at both ends of the first and second surfaces F1 and F2 of the paper P in the printing direction. That is, the gripping region GA is set at the first and second ends E1 and E2 of the first surface F1 of the paper P, and the gripping region GA is set at the first and second ends E1 and E2 of the second surface F2 of the paper P. Then, for the first surface F1, a region other than the gripping regions of both ends (region excluding the gripping regions GA of both ends from the entire first surface F1 of the paper P) is set as a first surface printable region PA1, and a first image printing region IA1 for printing a first image and a first test image printing region TA1 for printing a test image are set within the range of the set first surface printable region PA1. Then, for the second surface F2, a region other than the gripping regions of both ends (region excluding the gripping regions GA of both ends from the entire second surface F2 of the paper P) is set as a second surface printable region PA2, and a second image printing region IA2 for printing a second image and a second test image printing region TA2 for printing a test image are set within the range of the set second surface printable region PA2.

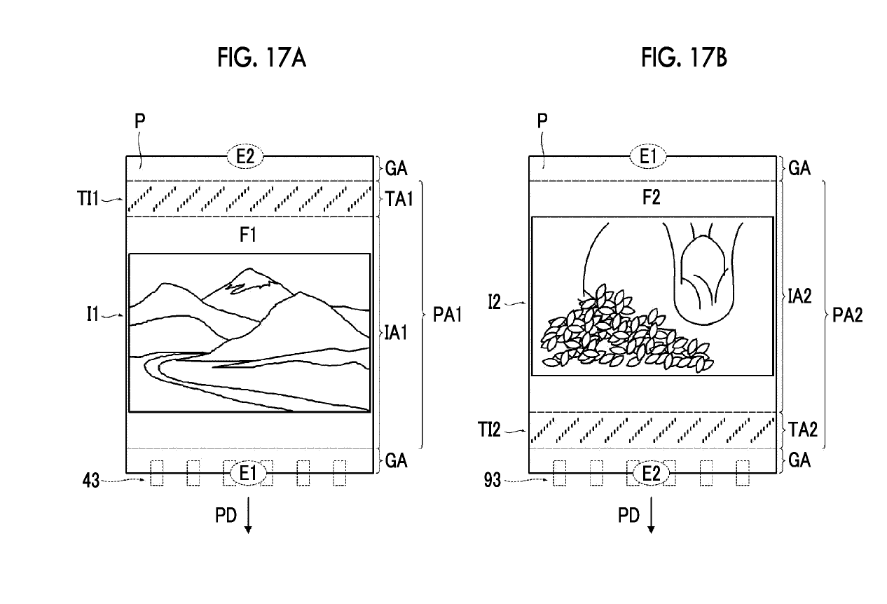

FIGS. 17A and 17B are conceptual diagrams of the setting of the print layout at the time of double-sided printing. FIG. 17A is a conceptual diagram of the setting of the print layout with respect to the first surface F1, and FIG. 17B is a conceptual diagram of the setting of the print layout with respect to the second surface F2.

[Print Layout of the First Surface F1]

As shown in FIG. 17A, for the first surface F1, the gripping region GA is set as a strip-shaped region having a fixed width, and is set at both ends of the first surface F1 in the printing direction (transport direction) PD. That is, the gripping region GA is set at the first and second ends E1 and E2. The widths of the gripping regions GA set at both ends are the same. Although the gripping region GA is set at both ends of the paper P in the printing direction, only the gripping region GA set at the first end E1 is gripped by the gripper at the time of printing of the first surface F1.

For the first surface F1, a region excluding the gripping region GA is set as the first surface printable region PA1. That is, a region interposed between the gripping regions GA at both ends is set as the first surface printable region PA1. The first surface printable region PA1 is set as a region that is not influenced by the deformation of the paper P due to gripping.

The first image printing region IA1 for printing the first image I1 that is a print target image on the first surface F1 and the first test image printing region TA1 for printing the first test image TI1 that is a test image on the first surface F1 are set within the first surface printable region PA1. The print layout setting unit 300 acquires position information for setting the first test image printing region TA1 from the print layout information, and sets the first image printing region IA1 and the first test image printing region TA1 within the first surface printable region PA1.

Similar to the single-sided printing, the first test image printing region TA1 is set as a region (strip-shaped region having a fixed width) crossing the paper P in a direction perpendicular to the printing direction PD. In addition, in this example, the first test image printing region TA1 is set in a rear end portion within the first surface printable region PA1 in the printing direction PD. The first test image TI1 is printed in the first test image printing region TA1.

The first image printing region IA1 is set as a region excluding the first test image printing region TA1 from the first surface printable region PA1. In this example, the first image printing region 1A1 is set between the gripping region GA on the front side in the printing direction PD and the first test image printing region TA1. The first image I1 that is a print target image on the first surface F1 is printed in the first image printing region IA1.

Thus, for the first surface F1, the gripping region GA is set at both ends of the paper P in the printing direction PD, and the first surface printable region PA1 is set between the gripping regions GA. The first image printing region IA1 is set on the front side of the first surface printable region PA1 in the printing direction PD, and the first test image printing region TA1 is set on the rear side of the first surface printable region PA1 in the printing direction PD. The print layout setting unit 300 generates a print image of the first surface F1 by arranging the test image TI1 in the first test image printing region TA1 and the first image I1 in the first image printing region IA1.

[Print Layout of the Second Surface F2]

As shown in FIG. 17B, for the second surface F2, the gripping region GA is set as a strip-shaped region having a fixed width, and is set at both ends of the second surface F2 in the printing direction (transport direction) PD. That is, the gripping region GA is set at the first and second ends E1 and E2. The widths of the gripping regions GA set at both ends are the same. The width of the gripping region GA set on the first surface F1 and the width of the gripping region GA set on the second surface F2 are the same. Although the gripping region GA is set at both ends of the paper P in the printing direction, only the gripping region GA set at the second end E2 is gripped by the gripper at the time of printing of the second surface F2.

Also for the second surface F2, similar to the first surface F1, a region excluding the gripping regions GA at both ends is set as the second surface printable region PA2. That is, a region interposed between the gripping regions GA at both ends is set as the second surface printable region PA2. The second surface printable region PA2 is set as a region that is not influenced by the deformation of the paper P due to gripping. Since the width of the gripping region GA set on the first surface F1 and the width of the gripping region GA set on the second surface F2 are the same, the second surface printable region PA2 set on the second surface F2 is set at the same position as the first surface printable region PA1 set on the first surface F1. That is, the first surface printable region PA1 and the second surface printable region PA2 are set so as to overlap each other when the paper P is seen therethrough from one surface side.

The second image printing region IA2 for printing the second image I2 that is a print target image on the second surface F2 and the second test image printing region TA2 for printing the second test image TI2 that is a test image on the second surface F2 are set within the second surface printable region PA2. The print layout setting unit 300 acquires position information for setting the second test image printing region TA2 from the print layout information, and sets the second image printing region IA2 and the second test image printing region TA2 within the second surface printable region PA2.

Here, the second test image printing region TA2 is set as a region (strip-shaped region having a fixed width) crossing the paper P in a direction perpendicular to the printing direction PD. In addition, the second test image printing region TA2 is set at the same position as the first test image printing region TA1 set on the first surface F1 so as to have the same width as the first test image printing region TA1 set on the first surface F1. That is, the second test image printing region TA2 is set so as to overlap the first test image printing region TA1 when the paper P is seen therethrough from the first surface F1 side. In this example, since the first test image printing region TA1 is set at the end of the first surface printable region PA1 on the second end E2 side, the second test image printing region TA2 is also set at the end of the second surface printable region PA2 on the second end E2 side. The second test image TI2 is printed in the second test image printing region TA2.

The second image printing region IA2 is set as a region excluding the second test image printing region TA2 from the second surface printable region PA2. In this example, the second image printing region IA2 is set between the gripping region GA on the rear side in the printing direction PD and the second test image printing region TA2. The second image printing region IA2 is also set in the same region as the first image printing region IA1. That is, the second image printing region IA2 is set so as to overlap the first image printing region IA1 when the paper P is seen therethrough from the first surface F1 side. The second image I2 that is a print target image on the second surface F2 is printed in the second image printing region IA2.

Thus, for the second surface F2, the gripping region GA is set at both ends of the paper P in the printing direction PD, and the second surface printable region PA2 is set between the gripping regions GA. The second image printing region IA2 is set on the rear side of the second surface printable region PA2 in the printing direction PD, and the second test image printing region TA2 is set on the front side of the second surface printable region PA2 in the printing direction PD. The print layout setting unit 300 generates a print image of the second surface F2 by arranging the second test image TI2 in the second test image printing region TA2 and the second image I2 in the second image printing region IA2.

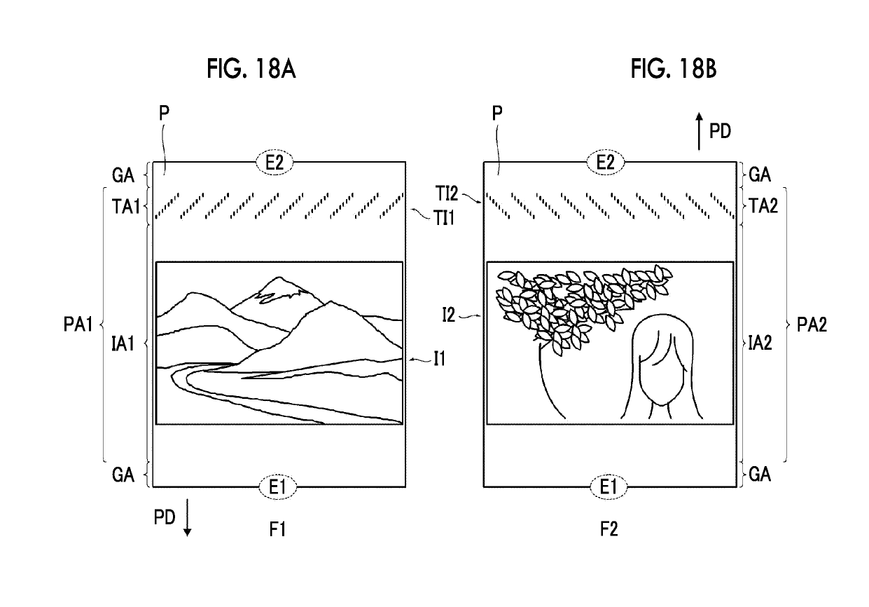

FIGS. 18A and 18B are diagrams showing an example of the print result at the time of double-sided printing. FIG. 18A illustrates an image printed on the first surface of the paper, and FIG. 18B illustrates an image printed on the second surface of the paper.

As shown in FIGS. 18A and 18B, on the first and second surfaces F1 and F2, printable regions (first and second surface printable regions PA1 and PA2) are set at the same position on the front and back surfaces, and image printing regions (first and second image printing regions IA1 and IA2) and test image printing regions (first and second test image printing regions TA1 and TA2) are set at the same position.

Thus, when printing a test image together with a print target image at the time of double-sided printing, an image printing region (first and second image printing regions IA1 and IA2) that is a region for printing the print target image (first and second images I1 and I2), a so-called client region that is wide can be secured by printing the print image and the test image by setting the image printing region (first and second image printing region 1A1 and TA2) and the test image printing region (first and second test image printing regions TA1 and TA2) at the same position of the front and back surfaces of the paper P. As a result, it is possible to efficiently use the paper P.

In addition, by setting the gripping region GA in consideration of the deformation of the paper P due to gripping, it is possible to accurately print the test image. In addition, the reading of the printed test image can also be accurately performed.

### Modification Examples of the Print Layout at the Time of Double-Sided Printing

In the example shown in FIGS. 17A and 17B, the first test image printing region TA1 set on the first surface F1 of the paper P is set at the end of the first surface printable region PA1 on the second end E2 side, and the second test image printing region TA2 is set at the end of the second surface printable region PA2 on the second end E2 side corresponding to the position setting of the first test image printing region TA1. However, the setting positions of the first test image printing region TA1 and the second test image printing region TA2 are not limited thereto. It is preferable that the first test image printing region TA1 and the second test image printing region TA2 are set at the same position on the front and back surfaces of the paper P. Therefore, the first test image printing region TA1 and the second test image printing region TA2 can also be set at the end on the first end E1 side. In addition, the first test image printing region TA1 and the second test image printing region TA2 do not necessarily need to be set at the end of the printable region, and can also be set so as to divide the printable region into two parts.

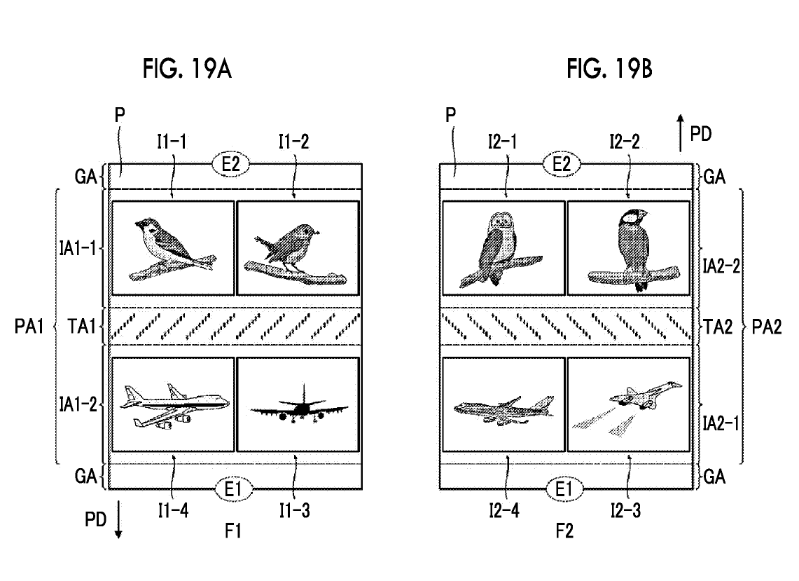

FIGS. 19A and 19B are diagrams showing a modification example of the print layout at the time of double-sided printing, and shows a case where a test image printing region is set in a region other than the end of the printable region. FIG. 19A shows an image printed on the first surface of the paper, and FIG. 19B shows an image printed on the second surface of the paper.

In the example shown in FIGS. 19A and 19B, the first test image printing region TA1 is set in the middle of the first surface printable region PA1, and the second test image printing region TA2 is set in the middle of the second surface printable region PA2 corresponding to the position setting of the first test image printing region TA1. In this case, the first surface printable region PA1 is divided into two parts on the front and rear sides in the printing direction PD with the first test image printing region TA1 interposed therebetween, and the second surface printable region PA2 is divided into two parts on the front and rear sides in the printing direction PD with the second test image printing region TA2 interposed therebetween. Accordingly, first image printing regions TA1-1 and IA1-2 are set in two places on the front and rear sides in the printing direction PD with the first test image printing region TA1 interposed therebetween, and second image printing regions IA2-1 and IA2-2 are set in two places on the front and rear sides in the printing direction PD with the second test image printing region TA2 interposed therebetween.

When the size of a print target image is small, it is possible to divide the printable region by setting the test image printing region in a region other than the end of the printable region as described above. In the example shown in FIGS. 19A and 19B, an example is shown in which two first images I1-1 and I1-2 are disposed in the first image printing region IA1-1 and two first images I1-3 and I1-4 are disposed in the first image printing region IA1-2, the first image printing regions IA1-1 and IA1-2 being set in two places of the first surface F1 of the paper P. Similarly, an example is shown in which two second images I2-1 and I2-2 are disposed in the second image printing region IA2-1 and two second images I2-3 and I2-4 are disposed in the second image printing region IA2-2, the second image printing regions IA2-1 and IA2-2 being set in two places of the second surface F2 of the paper P.

When the test image printing region is set at the end of the printable region, there are the following effects. That is, since the test image printed on the paper P is no longer required after checking, the test image printed on the paper P is cut from the paper P. In this case, it is possible to cut the test image from the paper P together with the gripping region by setting the test image printing region at the end of the printable region on the first end side or the end of the printable region on the second end side. Therefore, it is possible to efficiently remove unnecessary portions from the paper P.

### Other Printing Examples of the Test Image

As described above, in the double-sided printing method of the invention, test images are printed at the same position on the front and back surfaces of the paper at the time of double-sided printing. In this case, depending on the paper used, a test image printed on one surface is shown through the other surface (so-called show-through). This may reduce the reading accuracy. For example, in the case of printing on very thin paper or transparent or translucent paper (film), the reading accuracy of the reading unit is reduced due to the show-through (when the test image is a line pattern, the position of the center of gravity of the line may change due to the show-through). In such a case, it is possible to prevent a reduction in the test image reading accuracy of the reading unit by printing the test image as follows.

### Other Printing Examples (1) of the Test Image

The reduction in the test image reading accuracy occurs when a test image on the back surface side overlaps a test image on the front surface side due to the show-through. Accordingly, it is possible to avoid this problem by arranging the test images on the front and back surfaces so as not to overlap each other.

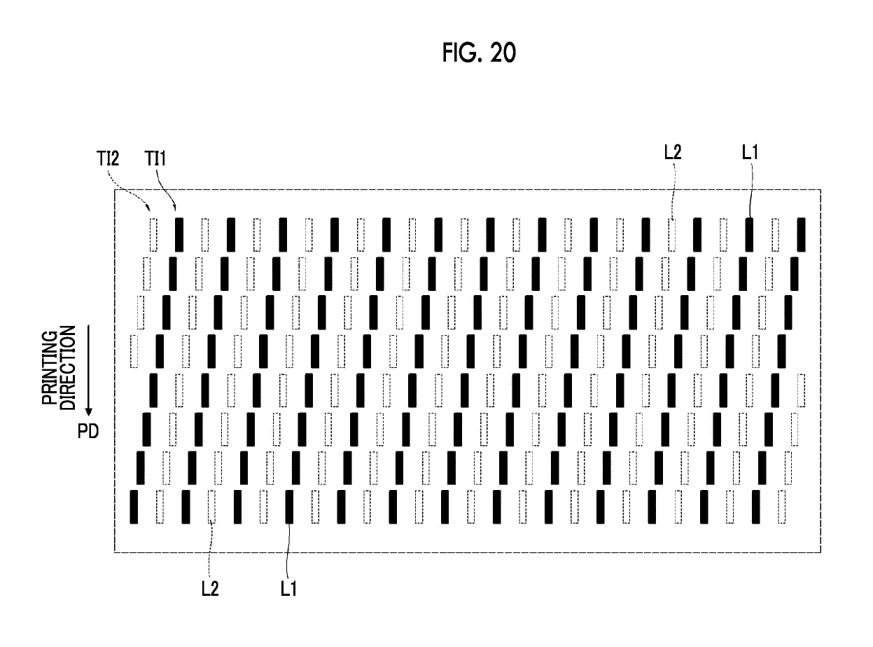

FIG. 20 is a diagram showing another printing example of the test image formed in a line pattern.

In FIG. 20, an image (line) on the second surface side shown through the first surface side is shown by the dotted line (a line L1 shown by the solid line is a line that forms the first test image TI1, and a line L2 shown by the dotted frame is a line that forms the second test image TI2).

As shown in FIG. 20, when forming the test image in a line pattern, line positions are set such that the lines do not overlap each other on the front and back surfaces of the paper. In the example shown in FIG. 20, each line L2 that forms the second test image TI2 is shifted by a predetermined amount in a direction perpendicular to the printing direction PD, so that the line L1 that forms the first test image TI1 and the line L2 that forms the second test image TI2 do not overlap each other. In particular, in the example shown in FIG. 20, each line L2 that forms the second test image TI2 is disposed at the intermediate position between the lines L1 that form the first test image TI1.

Thus, it is possible to prevent a reduction in the reading accuracy by setting the lines, which form test images on the front and back surfaces of the paper P, so as not to overlap each other.

### Other Printing Examples (2) of the Test Image

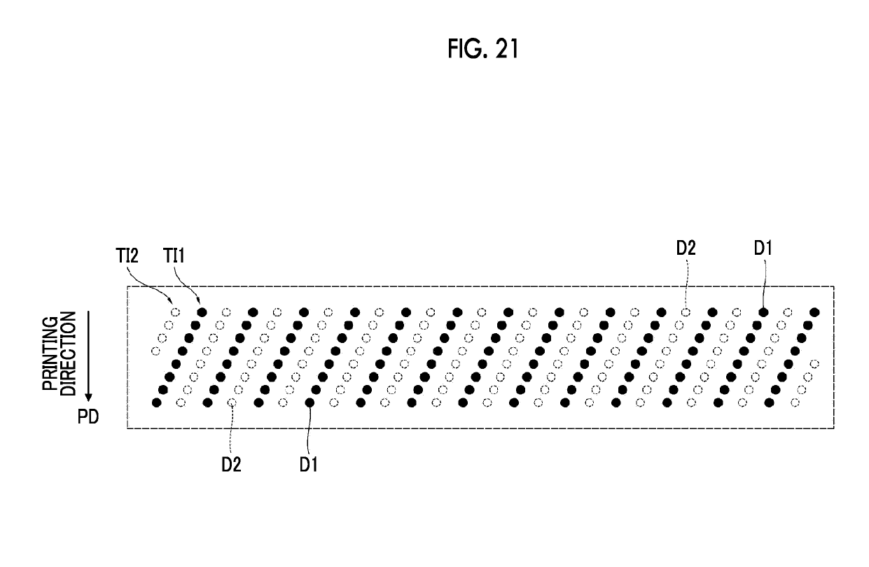

FIG. 21 is a diagram showing still another printing example of the test image formed in a dot pattern.

In FIG. 21, an image (dot) on the second surface side shown through the first surface side is shown by the dotted line (a dot D1 shown by the black circle is a dot that forms the first test image TI1, and a dot D2 shown by the dotted white circle is a dot that forms the second test image TI2).

As shown in FIG. 21, when forming the test image in a dot pattern, dot positions are set such that the dots do not overlap each other on the front and back surfaces of the paper. In the example shown in FIG. 21, each dot D2 that forms the second test image TI2 is shifted by a predetermined amount in a direction perpendicular to the printing direction PD, so that the dot D1 that forms the first test image TI1 and the dot D2 that forms the second test image TI2 do not overlap each other. In particular, in the example shown in FIG. 21, each dot D2 that forms the second test image TI2 is disposed at the intermediate position between the dots D1 that form the first test image TI1.

Thus, it is possible to prevent a reduction in the reading accuracy by setting the dots, which form test images on the front and back surfaces of the paper P, so as not to overlap each other.

### Other Printing Examples (3) of the Test Image

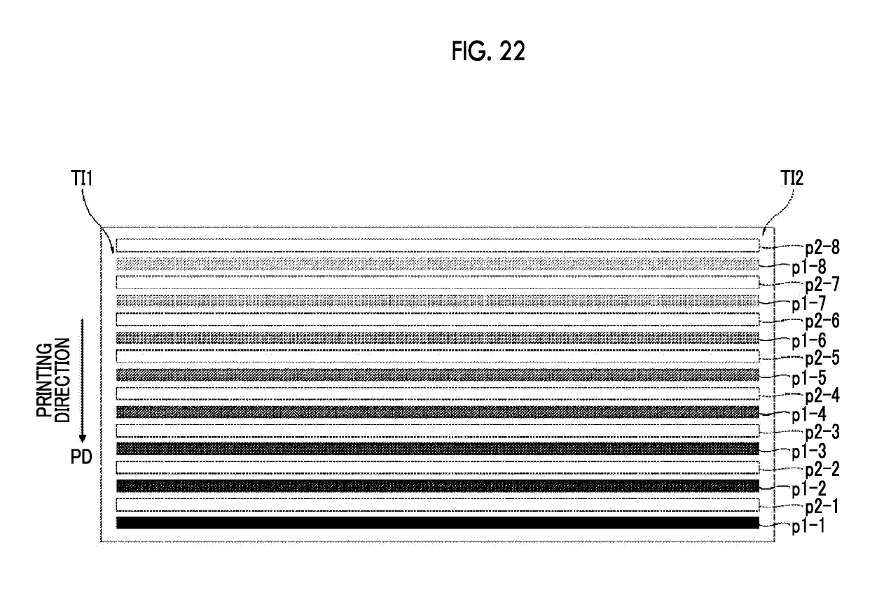

FIG. 22 is a diagram showing still another printing example of the test image formed by density patches.

In FIG. 22, an image (density patch) on the second surface side shown through the first surface side is shown by the dotted line (colored density patches p1-1 to p1-8 are density patches that form the first test image TI1, and density patches p2-1 to p2-8 shown by the white dotted frame are density patches that form the second test image TI2).

As shown in FIG. 22, when forming the test image with density patches, density patch positions are set such that the density patches do not overlap each other on the front and back surfaces of the paper. In the example shown in FIG. 22, density patches are set so as not to overlap each other on the front and back surfaces of the paper by arranging the density patches p2-1 to p2-8, which form the second test image TI2, between the density patches p1-1 to p1-8 that form the first test image TI1.

Thus, it is possible to prevent a reduction in the reading accuracy by setting the density patches, which form test images on the front and back surfaces of the paper P, so as not to overlap each other.

### Other Printing Examples (4) of the Test Image

In a system that reads a test image printed on the first surface before the printing of the second surface as the double-sided printing apparatus 1 of the embodiment described above, the problem of show-through occurs only when reading the test image printed on the second surface. That is, in this type of system, the problem of show-through cannot occur when reading the first surface. Therefore, it is preferable to take measures against the show-through only when reading the second surface.

Therefore, in the system that reads a test image printed on the first surface before the printing of the second surface as the double-sided printing apparatus 1 of the embodiment described above, it is possible to reduce the influence of show-through when reading the second surface by printing the test image as follows. That is, the density of the first test image printed in the first test image printing region of the first surface is set to be lower than the density of the second test image printed in the second test image printing region of the second surface.

By printing the first test image with the lower density than the second test image, it is possible to reduce the influence of show-through on the first surface even if the first and second test images are printed in the same region. As a result, it is possible to prevent a reduction in the reading accuracy of the second surface.

In the case of printing using an ink jet method, the density of the first test image can be set to be lower than the density of the second test image by changing the size of the ink droplet when printing the first test image and the size of the ink droplet when printing the second test image.

For example, when printing a test image formed in a line pattern in a double-sided printing apparatus in which an ink jet head capable of changing the size (volume) of the ink droplet to be discharged to three sizes (large size (large droplet), medium size (medium droplet), and small size (small droplet)) is mounted, the density of the first test image can be set to be lower than the density of the second test image by setting the size of the ink droplet when printing the first test image to be relatively smaller than the size of the ink droplet when printing the second test image.

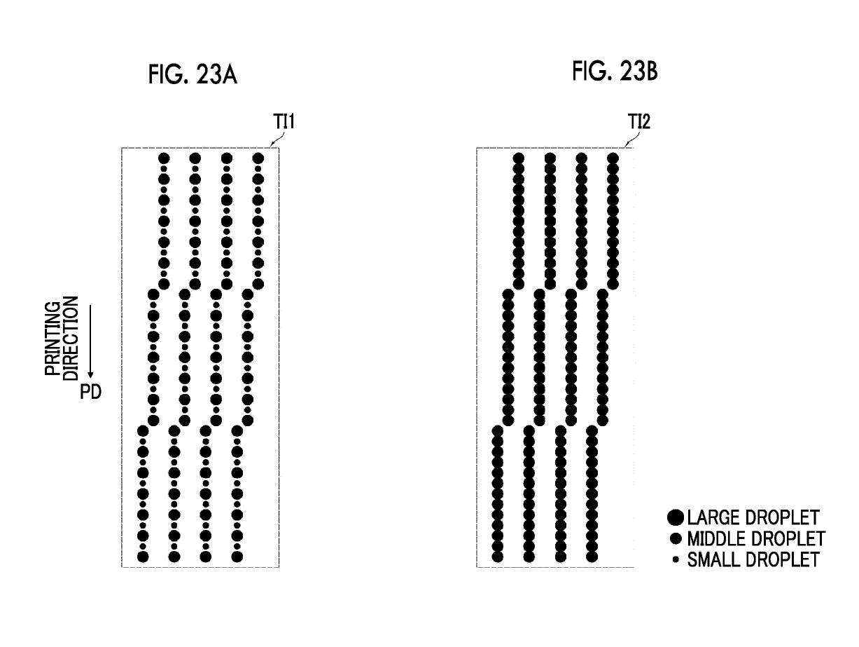

FIGS. 23A and 23B are diagrams showing an example of changing the density of the test image in the case of printing using an ink jet method. FIG. 23A shows a first test image printed in the first test image printing region of the first surface, and FIG. 23B shows a second test image printed in the second test image printing region of the second surface.

As shown in FIG. 23A, each line L1 that forms the first test image TI1 is set so as to be drawn by alternately discharging a medium-sized ink droplet (medium droplet) and a small-sized ink droplet (small droplet). On the other hand, each line L2 that forms the second test image TI2 is set so as to be drawn by discharging only the medium-sized ink droplet (medium droplet).

Thus, the density of the first test image TI1 can be set to be lower than the density of the second test image TI2.

### Other Printing Examples (5) of the Test Image

In a system that performs printing using a plurality of colors of ink as the double-sided printing apparatus 1 of the embodiment described above, it is possible to reduce the influence of show-through by setting the color of the first test image printed on the first surface of the paper and the color of the second test image printed on the second surface of the paper to different colors.

For example, in a system that performs printing using the ink of four colors of cyan (C), magenta (M), yellow (Y), and black (K) as the double-sided printing apparatus 1 of the embodiment described above, when switching the ink jet head to be checked for each sheet of paper (refer to FIG. 16), the ink color of the first test image printed in the first test image printing region of the first surface and the ink color of the second test image printed in the second test image printing region of the second surface are set to different colors on the same paper.

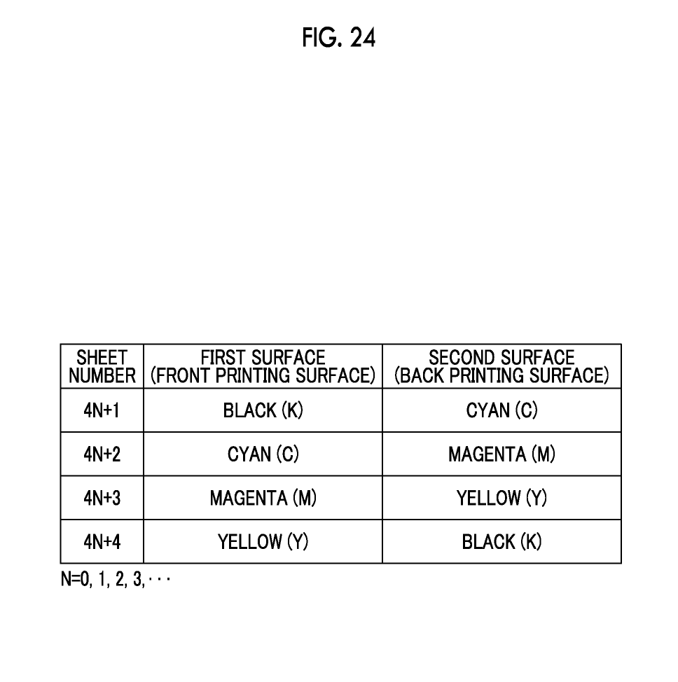

FIG. 24 is a table showing an example of setting ink colors used in the printing of the first test image and ink colors used in the printing of the second test image.

As shown in FIG. 24, the first surface is set such that the first test image is printed thereon by periodically switching the ink to be used in order of black (K), cyan (C), magenta (M), and yellow (Y) (by periodically switching ink jet heads for printing the first test image), and the second surface is set such that the second test image is printed thereon by periodically switching the ink to be used in order of cyan (C), magenta (M), yellow (Y), and black (K) (by periodically switching ink jet heads for printing the second test image). As a result, when N=0, 1, 2, 3, . . . is assumed, a first test image is printed with the ink of black (K) on the first surface of [4N+1]-th paper, and a second test image is printed with the ink of cyan (C) on the second surface of the [4N+1]-th paper. A first test image is printed with the ink of cyan (C) on the first surface of [4N+2]-th paper, and a second test image is printed with the ink of magenta (M) on the second surface of the [4N+2]-th paper. A first test image is printed with the ink of magenta (M) on the first surface of [4N+3]-th paper, and a second test image is printed with the ink of yellow (Y) on the second surface of the [4N+3]-th paper. A first test image is printed with the ink of yellow (Y) on the first surface of [4N+4]-th paper, and a second test image is printed with the ink of black (K) on the second surface of the [4N+4]-th paper.

Thus, by printing the first test image printed on the first surface and the second test image printed on the second surface with different colors, it is possible to reduce the influence of show-through. As a result, it is possible to prevent a reduction in the test image reading accuracy.

In the above example, the case of switching the ink jet head to be checked for each sheet of paper (refer to FIG. 16) has been described as an example. However, similarly for a case of checking all ink jet heads provided in the printing unit at once (refer to FIG. 15), it is also possible to reduce the influence of show-through by changing the colors of test images printed in the corresponding regions on the front and back surfaces of the paper.

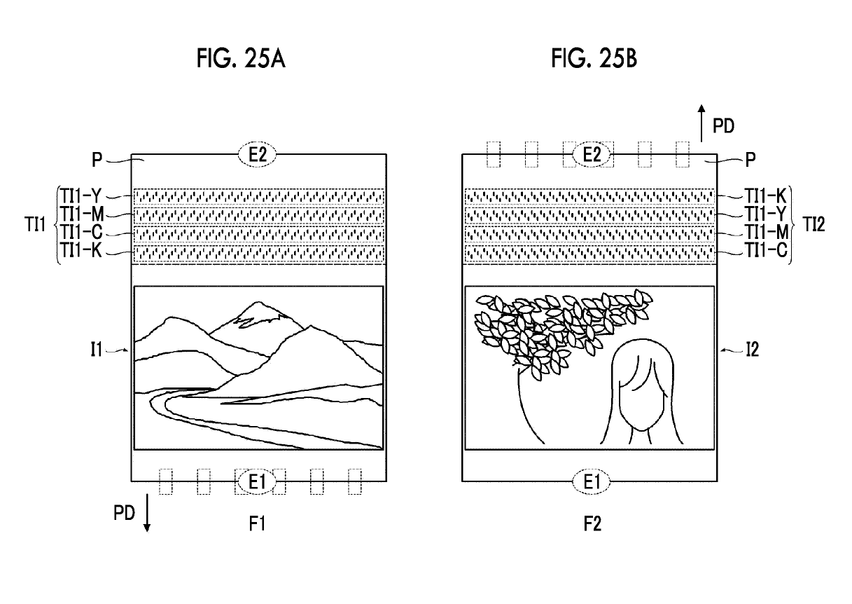

FIGS. 25A and 25B are diagrams showing a printing example when changing the colors of test images printed in the corresponding regions on the front and back surfaces of the paper in the case of checking all ink jet heads provided in the printing unit at once.

As shown in FIGS. 25A and 25B, each test image is an image obtained by combining a test image for the cyan ink jet head, a test image for the magenta ink jet head, a test image for the yellow ink jet head, and a test image for the black ink jet head. In this case, the test image TI1 to be printed in the first test image printing region TA1 is formed by arranging the test image TI1-K for the black ink jet head, the test image TI1-C for the cyan ink jet head, the test image TI1-M for the magenta ink jet head, and the test image TI1-Y for the yellow ink jet head in this order in the printing direction PD. On the other hand, the second test image TI2 to be printed in the second test image printing region TA2 is formed by arranging a test image TI2-K for the black ink jet head, a test image TI2-Y for the yellow ink jet head, a test image TI2-M for the magenta ink jet head, and a test image TI2-C for the cyan ink jet head in this order in the printing direction PD. Accordingly, the cyan test image TI2-C is printed on the back (corresponding region of the second surface) of the black test image TI1-K of the first surface, the magenta test image TI2-M is printed on the back of the cyan test image TI1-C of the first surface, the yellow test image TI2-Y is printed on the back of the magenta test image TI1-M of the first surface, and the black test image T12-K is printed on the back of the yellow test image TI1-Y of the first surface.

### Other Printing Examples (6) of the Test Image

In the case of printing using the ink of a plurality of colors, when black ink is included in the ink to be used (when the ink jet head for discharging the black ink is included), the influence of show-through is the largest when the color of the ink on the corresponding back side is black.

Therefore, as in the printing example (6) described above, in the case of setting the color of the first test image printed on the first surface of the paper and the color of the second test image printed on the second surface of the paper to different colors, if black ink is included in the ink to be used, the color of the second test image printed in the second test image printing region is also set to black when the color of the first test image printed in the first test image printing region is set to black.

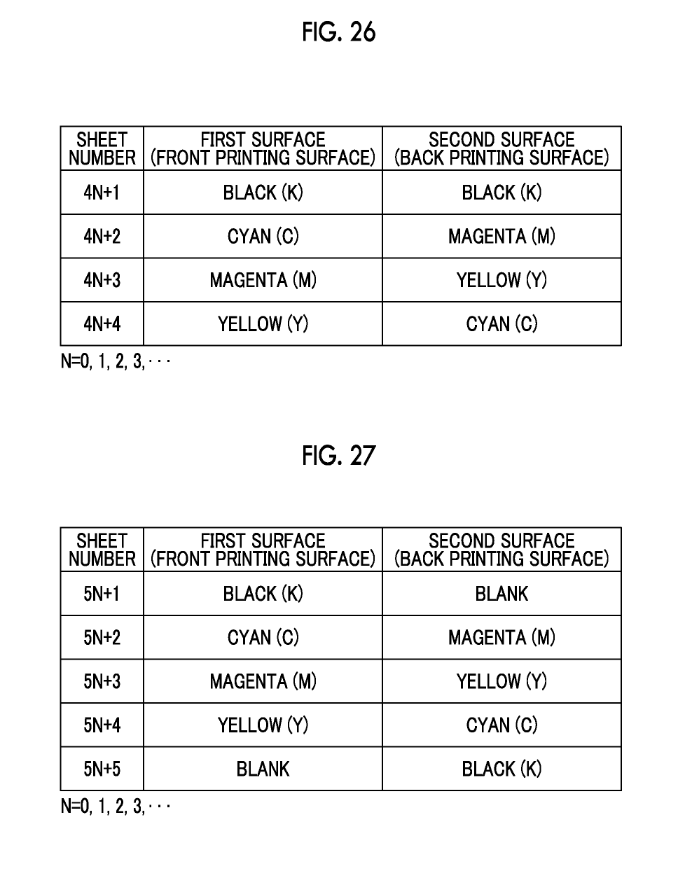

FIG. 26 is a table showing an example of setting ink colors used in the printing of the first test image and ink colors used in the printing of the second test image.

As shown in FIG. 26, the first surface is set such that the first test image is printed thereon by periodically switching the ink to be used in order of black (K), cyan (C), magenta (M), and yellow (Y), and the second surface is set such that the second test image is printed thereon by periodically switching the ink to be used in order of black (K), magenta (M), yellow (Y), and cyan (C). As a result, when N=0, 1, 2, 3, . . . is assumed, a first test image is printed with the ink of black (K) on the first surface of [4N+1]-th paper, and a second test image is printed with the ink of black (K) on the second surface of the [4N+1]-th paper. A first test image is printed with the ink of cyan (C) on the first surface of [4N+2]-th paper, and a second test image is printed with the ink of magenta (M) on the second surface of the [4N+2]-th paper. A first test image is printed with the ink of magenta (M) on the first surface of [4N+3]-th paper, and a second test image is printed with the ink of yellow (Y) on the second surface of the [4N+3]-th paper. A first test image is printed with the ink of yellow (Y) on the first surface of [4N+4]-th paper, and a second test image is printed with the ink of cyan (C) on the second surface of the [4N+4]-th paper.

Therefore, in the case of setting the color of the first test image printed on the first surface of the paper and the color of the second test image printed on the second surface of the paper to different colors, if black ink is included in the ink to be used, the second test image is also printed with black ink on the second surface when the first test image is printed with black ink on the first surface. In this manner, it is possible to further reduce the influence of show-through when reading the test image.

Similarly for a case of checking all ink jet heads provided in the printing unit at once, it is possible to reduce the influence of show-through by matching the positions of test images printed with black on the front and back surfaces of the paper.

### Other Printing Examples (7) of the Test Image

In the printing example (6) described above, when the color of the first test image printed on the first surface is set to black, the color of the second test image printed on the second surface is also set to black in order to reduce the influence of show-through. In this example, however, when the color of the first test image printed on one surface is black, no test image is printed on the other surface. That is, when the color of the test image printed on the first surface is black, no test image is printed on the second surface. Similarly, when the color of the test image printed on the second surface is black, no test image is printed on the first surface.

FIG. 27 is a table showing an example of setting ink colors used in the printing of the first test image and ink colors used in the printing of the second test image.

As shown in FIG. 27, the first surface is set such that the first test image is printed thereon by periodically switching the ink to be used in order of black (K), cyan (C), magenta (M), yellow (Y), and blank, and the second surface is set such that the second test image is printed thereon by periodically switching the ink to be used in order of blank, magenta (M), yellow (Y), cyan (C), and black (K). As a result, when N=0, 1, 2, 3, . . . is assumed, a first test image is printed with the ink of black (K) on the first surface of [5N+1]-th paper, and a second test image printing region is blank on the second surface of the [5N+1]-th paper. A first test image is printed with the ink of cyan (C) on the first surface of [5N+2]-th paper, and a second test image is printed with the ink of magenta (M) on the second surface of the [5N+2]-th paper. A first test image is printed with the ink of magenta (M) on the first surface of [5N+3]-th paper, and a second test image is printed with the ink of yellow (Y) on the second surface of the [5N+3]-th paper. A first test image is printed with the ink of yellow (Y) on the first surface of [5N+4]-th paper, and a second test image is printed with the ink of cyan (C) on the second surface of the [5N+4]-th paper. A first test image printing region of the first surface is blank on [5N+5]-th paper, and a second test image is printed with the ink of black (K) on the second surface of the [5N+5]-th paper.

Thus, in the case of setting the color of the first test image printed on the first surface of the paper and the color of the second test image printed on the second surface of the paper to different colors, when the color of the first test image printed on one surface is black, it is possible to further reduce the influence of show-through when reading the test image by setting no test image to be printed on the other surface.

Similarly for a case of checking all ink jet heads provided in the printing unit at once, it is possible to reduce the influence of show-through by setting the back side of the test image printed in black to blank.

Although the blank is applied in the example described above, reading may not be performed after printing.

### Other Forms of the Test Image

The test image printing methods described in the printing examples (1) to (7) can be appropriately used in combination. In this case, it is possible to prevent a reduction in the reading accuracy more effectively.

### Other Forms of the Transportation Unit in the Reading Unit

By forming the paper transportation unit in the reading unit as follows, it is possible to prevent a reduction in the reading accuracy due to the show-through.

That is, in the case of transporting the paper by adsorbing and holding the paper on the suction surface, the suction surface of a region that is brought into contact with the test image printing region when the paper is adsorbed and held is colored with a density equal to or greater than the highest density that can be printed by the printing unit. In this case, it is possible to prevent a reduction in the test image reading accuracy due to the show-through.

In the double-sided printing apparatus 1 of the embodiment described above, since the second scanner 98 that reads the second test image printed on the second surface is provided on the transport path of the second printing drum 92, a relevant portion of the peripheral surface of the second printing drum 92 is colored with a density equal to or greater than the highest density that can be printed by the first printing unit 40.

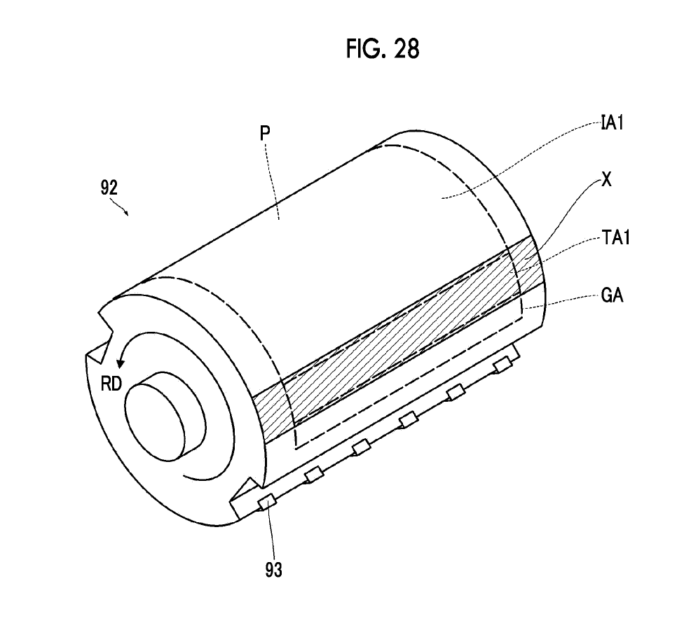

FIG. 28 is a perspective view of a second printing drum whose part of the peripheral surface is colored. In FIG. 28, reference numeral RD indicates the rotation direction of the drum (transport direction of the paper).

As shown in FIG. 28, on the peripheral surface of the second printing drum 92, a region that is brought into contact with the first test image printing region TA1 set on the first surface F1 of the paper P when transporting the paper P, that is, a region X (shaded region in FIG. 28) covered by the first test image printing region TA1, is colored with a density equal to or greater than the highest density that can be printed by the first printing unit 40. For example, the region X is colored with a density equal to or greater than the highest density of black.

In this manner, since it is possible to reduce the influence of show-through of the test image printed on the first surface, it is possible to stably read the second test image.

In addition, although only a part of the peripheral surface of the second printing drum 92 is colored in the example shown in FIG. 28, it is also possible to adopt a configuration in which the entire surface is colored. That is, it is preferable that at least a region in contact with the first test image printing region TA1 is colored.

### Second Embodiment

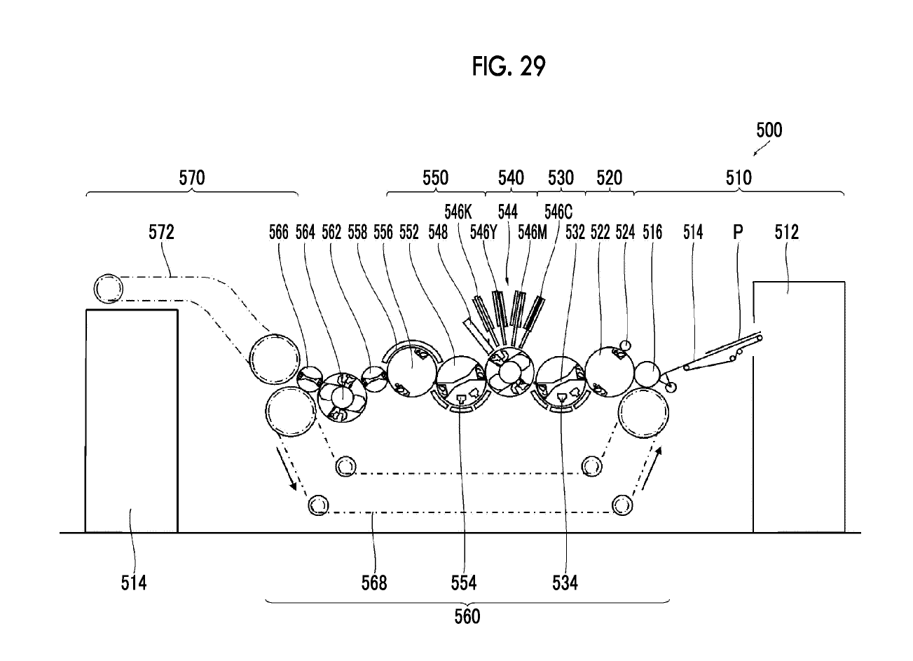

FIG. 29 is a diagram showing the overall configuration of a double-sided printing apparatus according to a second embodiment.

In the double-sided printing apparatus of the first embodiment shown in FIG. 1, each surface of the paper is printed by the printing units provided in two places. In a double-sided printing apparatus 500 of the present embodiment, however, both surfaces of the paper P are printed by making the paper P pass through the printing unit provided in one place twice. That is, both surfaces of the paper P are printed by printing the first surface in the first paper passing and the second surface in the second paper passing. For this reason, in the double-sided printing apparatus 500 of the present embodiment, the second processing liquid application unit 70, the second processing liquid drying unit 80, the second printing unit 90, and the second ink drying unit 100 provided in the double-sided printing apparatus 1 of the first embodiment are not provided. Instead, a mechanism for reversing the front and back surfaces of the paper P and returning the paper P to the feed drum is provided.

As shown in FIG. 29, the double-sided printing apparatus 500 is mainly configured to include a paper feed unit 510 that feeds the paper P, a processing liquid application unit 520 that applies a predetermined processing liquid onto the paper P fed from the paper feed unit 510, a processing liquid drying unit 530 that dries the paper P onto which the processing liquid has been applied, a printing unit 540 that prints an image on the dried paper P using an ink jet method, an ink drying unit 550 that dries the printed paper P, a reverse transportation unit 560 that reverses the front and back surfaces of the dried paper P and returns the paper P to the paper feed unit 510, and a stacking unit 570 that stacks the printed paper P.

### Paper Feed Unit

The paper feed unit 510 feeds the paper P, which is a medium, one by one. The paper feed unit 510 is mainly configured to include a paper feeder 512, a feeder board 514, and a feed drum 516. The configuration of the paper feed unit 510 is the same as that of the paper feed unit 10 of the double-sided printing apparatus 1 of the first embodiment.

### Processing Liquid Application Unit

The processing liquid application unit 520 applies a predetermined processing liquid onto the paper P. The processing liquid application unit 520 is mainly configured to include a processing liquid application drum 522 for transporting the paper P and a processing liquid application device 524 for applying the processing liquid onto the paper P transported by the processing liquid application drum 522.

The processing liquid application unit 520 applies a predetermined processing liquid onto the paper P. The processing liquid application unit 520 is mainly configured to include a processing liquid application drum 522 for transporting the paper P and a processing liquid application device 524 for applying the processing liquid onto the paper P transported by the processing liquid application drum 522. The configuration of the processing liquid application unit 520 is the same as that of the first processing liquid application unit 20 of the double-sided printing apparatus 1 of the first embodiment.

### Processing Liquid Drying Unit

The processing liquid drying unit 530 dries the paper P onto which the processing liquid has been applied. The processing liquid drying unit 530 is mainly configured to include a processing liquid drying drum 532 for transporting the paper P and a processing liquid drying device 534 for drying the paper P by blowing warm air to the paper P transported by the processing liquid drying drum 532. The configuration of the processing liquid drying unit 530 is the same as that of the first processing liquid drying unit 30 of the double-sided printing apparatus 1 of the first embodiment.

### Printing Unit

The printing unit 540 prints a color image on the paper P in the ink jet method using the ink of four colors of cyan (C), magenta (M), yellow (Y), and black (K). The printing unit 540 is mainly configured to include a printing drum 542 for transporting the paper P, a head unit 544 that prints a color image on the paper P by discharging ink droplets of the colors of C, M, Y, and K toward the paper P transported by the printing drum 542, and a scanner 548 as a reading unit that reads the image printed on the paper P. The configuration of the printing unit 540 is the same as that of the first printing unit 40 of the double-sided printing apparatus 1 of the first embodiment. Accordingly, the head unit 544 as an example of the printing unit is configured to include an ink jet head 546C for discharging ink droplets of cyan, an ink jet head 546M for discharging ink droplets of magenta, an ink jet head 546Y for discharging ink droplets of yellow, and an ink jet head 546K for discharging ink droplets of black, and is disposed on the transport path of the printing drum 542 that is an example of the transportation unit.

### Ink Drying Unit

The ink drying unit 550 dries the paper P immediately after the printing by the printing unit 540. The ink drying unit 550 is mainly configured to include a pre-drying drum 552 for transporting the paper P, a pre-drying device 554 that pre-dries the paper P by blowing warm air to the paper P transported by the pre-drying drum 552, an ink drying drum 556 for transporting the paper P, and an ink drying device 558 that dries the paper P by blowing warm air to the paper P transported by the ink drying drum 556. The configuration of the ink drying unit 550 is the same as that of the first ink drying unit 50 of the double-sided printing apparatus 1 of the first embodiment.

### Reverse Transportation Unit

The reverse transportation unit 560 reverses the front and back surfaces of the paper P by reversing the front and rear sides of the paper P and returns the reversed paper P to the paper feed unit 510 to feed the paper again. The reverse transportation unit 560 is mainly configured to include a first pass drum 562, a second pass drum 564, a reversing drum 566, and a chain gripper for reverse transport 568.

The configuration of the first pass drum 562, the second pass drum 564, and the reversing drum 566 provided in the reverse transportation unit 560 is the same as the configuration of the first pass drum 62, the second pass drum 64, and the reversing drum 66 provided in the reversing unit 60 of the double-sided printing apparatus 1 of the first embodiment. Accordingly, the mechanism of reversal is the same as the mechanism of the reversing unit 60 of the double-sided printing apparatus 1 of the first embodiment. That is, the front and back surfaces of the paper P are reversed by reversing the front and rear surfaces of the paper P through grip switching between the front and rear sides of the paper P between the second pass drum 564 and the reversing drum 566. Similar to the reversing unit 60 of the double-sided printing apparatus 1 of the first embodiment, it is possible to transport the paper P without reversing the paper P. In this case, the paper P is transported without performing grip switching between the front and rear sides of the paper P between the second pass drum 564 and the reversing drum 566.

The chain gripper for reverse transport 568 is configured to include a pair of endless chains disposed along the transport path of the paper P and a plurality of grippers disposed at fixed distances in the chain. The chain gripper for reverse transport 568 receives the paper P from the reversing drum 566, transports the received paper P along the predetermined transport path, and passes the paper P to the feed drum 516 of the paper feed unit 510.

Depending on the printing form and the progress of printing, the reverse transportation unit 560 determines whether or not to reverse the paper and whether or not to switch the transport direction of the paper.

That is, at the time of single-sided printing, the paper P received from the ink drying unit 550 is transported to the stacking unit 570 located in the subsequent stage without reversing the paper.

On the other hand, at the time of double-sided printing, the reverse transportation unit 560 determines whether or not to reverse the paper and whether or not to switch the transport direction of the paper depending on the progress of printing. That is, after printing the first surface, the paper is reversed and returned to the paper feed unit 510. After printing the second surface, the paper is transported to the stacking unit 570 without reversing the paper.

### Stacking Unit

The stacking unit 570 stacks the printed paper P in one place. The stacking unit 570 is mainly configured to include a chain gripper for stacking 572 for transporting the paper P and an stacking device 574 that receives and stacks the paper P transported by the chain gripper for stacking 572. The configuration of the stacking unit 570 is the same as that of the stacking unit 110 of the double-sided printing apparatus 1 of the first embodiment.

### Control System

The basic configuration is the same as that of the control system of the double-sided printing apparatus 1 of the first embodiment. A system controller controls the overall operation. In addition, the system controller performs a print layout setting and the like.

### Operation of the Double-Sided Printing Apparatus

### Overview of Single-Sided Printing and Double-Sided Printing

The double-sided printing apparatus 500 of the present embodiment can also perform single-sided printing and double-sided printing. The paper P is stacked after passing through the printing unit 540 only once at the time of single-sided printing, and the paper P is stacked after passing through the printing unit 540 twice at the time of double-sided printing.

At the time of double-sided printing, similar to the double-sided printing apparatus 1 of the first embodiment, the front and back surfaces of the paper P are reversed after the printing of the first surface F1. At the time of reversing, the front and back surfaces of the paper P are reversed by performing grip switching between the front and rear sides of the paper P. Accordingly, at the time of printing of the first surface F1 and printing of the second surface F2, the front and rear relationship of the ends with respect to the transport direction of the paper P is reversed. That is, at the time of printing of the first surface F1, the first end E1 of the paper P is located on the front side in the printing direction (transport direction), and the paper P is transported in a state in which the first end E1 is gripped by the gripper G (refer to FIG. 13A). On the other hand, at the time of printing of the second surface F2, the second end E2 of the paper P is located on the front side in the printing direction (transport direction), and the paper P is transported in a state in which the second end E2 is gripped by the gripper G (refer to FIG. 13B).

### Flow of the Printing Process at the Time of Single-Sided Printing

The process of single-sided printing is performed in order of (a) paper feed, (b) application of the processing liquid onto the first surface, (c) drying of the processing liquid applied onto the first surface, (d) printing on the first surface, (e) reading of the test image printed on the first surface, (f) drying of ink, and (g) stacking.

When a print job is received, the double-sided printing apparatus reads image data of a print target image included in the print job, and sets the print layout. Then, image data of an image to be actually printed is generated, and dot arrangement data for printing in the first printing unit 40 is generated from the generated image data. After generating the dot arrangement data, printing is started according to the content designated by the print job.

When the printing is started, paper feeding is started from the paper feed unit 510. The paper P fed from the paper feed unit 510 is first transported to the processing liquid application unit 520, so that the processing liquid is applied onto the first surface F1 by the processing liquid application unit 520. Then, the paper P having the first surface F1 onto which the processing liquid has been applied is transported to the processing liquid drying unit 530. Then, drying processing is performed by the processing liquid drying unit 530. Then, the dried paper P is transported to the printing unit 540. Then, an image is printed on the first surface F1 by the printing unit 540. Then, for the paper P having the first surface F1 on which the image is printed, the test image printed on the first surface F1 is read by the printing unit 540. The reading is performed by the scanner 548 provided in the printing unit 540, and is performed immediately after printing onto the first surface F1. Then, the paper P from which the test image has been read is transported to the ink drying unit 550. Then, drying processing is performed by the ink drying unit 550. The dried paper P is transported to the reverse transportation unit 560. The paper P transported to the reverse transportation unit 560 is transported to the stacking unit 570 as it is without performing reversal processing. That is, the paper P is passed to the first pass drum 562 from the ink drying drum 556 of the ink drying unit 550, passed to the second pass drum 564 from the first pass drum 562, passed to the reversing drum 566 from the second pass drum 564, and passed to the chain gripper for stacking 572 of the stacking unit 570 from the reversing drum 566. Eventually, the paper P is transported to the stacking unit 570. The paper P transported to the stacking unit 570 is transported to the stacking position by the chain gripper for stacking 572, and is stacked on the stacking device 574.

Thus, at the time of single-sided printing, printing is performed by making the paper P pass through the printing unit 540 only once.

### Flow of the Printing Process at the Time of Double-Sided Printing

The process of double-sided printing is performed in order of (a) paper feed, (b) application of the processing liquid onto the first surface, (c) drying of the processing liquid applied onto the first surface, (d) printing on the first surface (first surface printing step), (e) reading of the test image printed on the first surface, (f) drying of ink, (g) reversing of the front and back surfaces of paper, (h) application of the processing liquid onto the second surface, (i) drying of the processing liquid applied to the second surface, (j) printing on the second surface (second surface printing step), (k) reading of the test image printed on the second surface, (l) drying of ink, and (m) stacking.

When a print job is received, the double-sided printing apparatus reads image data of a print target image included in the print job, and sets the print layout. Then, image data of an image to be actually printed is generated, and dot arrangement data for printing in the printing unit 540 is generated from the generated image data. After generating the dot arrangement data, printing is started according to the content designated by the print job.

When the printing is started, paper feeding is started from the paper feed unit 510. The paper P fed from the paper feed unit 510 is first transported to the processing liquid application unit 520, so that the processing liquid is applied onto the first surface F1 by the processing liquid application unit 520. Then, the paper P having the first surface F1 onto which the processing liquid has been applied is transported to the processing liquid drying unit 530. Then, drying processing is performed by the processing liquid drying unit 530. Then, the dried paper P is transported to the printing unit 540. Then, an image is printed on the first surface F1 by the printing unit 540 (first surface printing step). In this case, the paper P is transported in a state in which the first end E1 is gripped. Then, for the paper P having the first surface F1 on which the image is printed, the test image printed on the first surface F1 is read by the printing unit 540. The reading is performed by the scanner 548 provided in the printing unit 540, and is performed immediately after printing onto the first surface F1. Then, the paper P from which the test image has been read is transported to the ink drying unit 550. Then, drying processing is performed by the ink drying unit 550. Then, the dried paper P is transported to the reverse transportation unit 560. The paper P transported to the reverse transportation unit 560 is returned to the paper feed unit 510 after the front and back surfaces of the paper P are reversed. That is, the paper P is passed to the first pass drum 562 from the ink drying drum 556 of the ink drying unit 550, passed to the second pass drum 564 from the first pass drum 562, passed to the reversing drum 566 from the second pass drum 564, passed to the chain gripper for reverse transport 568 from the reversing drum 566, and passed to the feed drum 516 of the paper feed unit 510 from the chain gripper for reverse transport 568. Eventually, the paper P is returned to the paper feed unit 510.

The paper P returned to the paper feed unit 510 is transported again to the processing liquid application unit 520, so that the processing liquid is applied onto the second surface F2 by the processing liquid application unit 520. Then, the paper P having the second surface F2 onto which the processing liquid has been applied is transported to the processing liquid drying unit 530. Then, drying processing is performed by the processing liquid drying unit 530. Then, the dried paper P is transported to the printing unit 540. Then, an image is printed on the second surface F2 by the printing unit 540 (second surface printing step). In this case, the paper P is transported in a state in which the second end E2 is gripped. Then, for the paper P having the second surface F2 on which the image is printed, the test image printed on the second surface F2 is read by the printing unit 540. The reading is performed by the scanner 548 provided in the printing unit 540, and is performed immediately after printing onto the second surface F2. Then, the paper P from which the test image has been read is transported to the ink drying unit 550. Then, drying processing is performed by the ink drying unit 550. Then, the dried paper P is transported to the reverse transportation unit 560. The paper P transported to the reverse transportation unit 560 is transported to the stacking unit 570 as it is without performing reversal processing. That is, the paper P is passed to the first pass drum 562 from the ink drying drum 556 of the ink drying unit 550, passed to the second pass drum 564 from the first pass drum 562, passed to the reversing drum 566 from the second pass drum 564, and passed to the chain gripper for stacking 572 of the stacking unit 570 from the reversing drum 566. Eventually, the paper P is transported to the stacking unit 570. The paper P transported to the stacking unit 570 is transported to the stacking position by the chain gripper for stacking 572, and is stacked on the stacking device 574.

Thus, at the time of double-sided printing, processing for reversing the paper P is performed after printing onto the first surface F1 and the paper P is made to pass through the same printing unit 540 again, thereby performing printing on both surfaces of the paper P.

### Printing Layout Setting

The print layout of the image printed by the double-sided printing apparatus 500 of the present embodiment is set in the same manner as in the double-sided printing apparatus 1 of the first embodiment. That is, at the time of double-sided printing, image printing regions (first and second image printing regions TA1 and IA2) and test image printing regions (first and second test image printing regions TA1 and TA2) are set at the same position on the front and back surfaces of the paper P. In this case, since it is possible to secure the so-called client region that is wide, it is possible to efficiently use the paper P.

### Other Forms of the Printing Drum

Also in the double-sided printing apparatus 500 of the present embodiment, it is possible to prevent the test image reading accuracy from being reduced due to the printing drum 542 including the scanner being colored. That is, by coloring a region, which is brought into contact with the first test image printing region TA1 set on the first surface F1 of the paper P when transporting the paper P, with a density equal to or greater than the highest density that can be printed by the printing unit 540, it is possible to prevent a reduction in the reading accuracy due to the show-through. Therefore, it is possible to stably read the test image.

### Other Embodiments

### Other Examples of the Transportation Unit

In the series of embodiments described above, a drum and a chain gripper are adopted as a paper transportation unit. However, the paper transportation unit is not limited thereto. For example, it is also possible to adopt a belt type transportation unit, that is, a transportation unit that transports paper by adsorbing and holding the paper on the peripheral surface of a belt that is rotating. When the belt type transportation unit is adopted as a paper transportation unit in the reading unit, it is possible to prevent a reduction in the reading accuracy due to the show-through by coloring the peripheral surface of the belt.

### Other Examples of the Printing Method

Although the case where the invention is applied to the ink jet type printing apparatus has been described as an example in the above embodiments, the application of the invention is not limited thereto. For example, the invention can also be applied to a rotary press or a thermal printer (printer using a thermal method that performs printing by applying a print head onto dedicated paper (thermal paper) whose color is changed when heated) or a laser printer (printer that performs printing by making toner adhere to a photosensitive body using a laser beam and transferring the toner onto paper by heat and pressure).

### Other Examples of the Double-Sided Printing Method

Although the case where double-sided printing is performed by automatically reversing the paper has been described as an example in the above embodiments, the invention can also be applied to a case of performing double-sided printing by manually reversing the paper. That is, the invention can be applied to any printing form in which grip switching between the front and rear sides of the paper is performed at the time of printing of the first surface and at the time of printing of the second surface.

### Reading of the Test Image

Although the reading of the test image is performed in the printing apparatus in the embodiments described above, the reading of the test image may be performed outside the printing apparatus. That is, a test image after printing can also be read by a different reader from the double-sided printer.

In addition, although the configuration in which the reading unit is provided on the transport path of the transportation unit that transports the paper at the time of printing (that is, the scanner is provided on the printing drum) and the image is read immediately after printing is adopted in the embodiments described above, the position where the reading unit is provided is not limited thereto. For example, it is also possible to read the image after ink drying.

The configuration of the double-sided printing apparatus can be appropriately changed according to the medium to be used, ink to be used, or the like. For example, when ultraviolet curable type ink is used, an ultraviolet irradiation unit is separately provided. When ink jet paper is used as media, the processing liquid application unit is not required. In addition, when coating the paper after printing, a coating unit is separately provided.

What is claimed is:

1. A double-sided printing method, comprising:
when one surface of a medium is a first surface and the other surface of the medium is a second surface, an end of the first surface on a front side from the first surface in a printing direction is a first end of the medium, and an end of the first surface on a rear side from the first surface in the printing direction is a second end of the medium,
a first surface printing step of transporting the medium along a first transport path by gripping the first end and printing a first image and a first test image in a single pass on the first surface of the medium using a first printing unit provided on the first transport path; and
a second surface printing step of transporting the medium along a second transport path by gripping the second end after the first surface printing step and printing a second image and a second test image in a single pass on the second surface of the medium using a second printing unit provided on the second transport path,
wherein a gripping region is set at each of the first and second ends of the medium,
a region of the first surface excluding the gripping region is set as a first surface printable region, and a first image printing region for printing the first image and a first test image printing region for printing the first test image are set in the first surface printable region,
a region of the second surface excluding the gripping region is set as a second surface printable region, and a second image printing region for printing the second image and a second test image printing region for printing the second test image are set in the second surface printable region, and
the first and second test image printing regions are set in the same region of the first and second surfaces.

2. A double-sided printing method, comprising:
when one surface of a medium is a first surface and the other surface of the medium is a second surface, an end of the first surface on a front side from the first surface in a printing direction is a first end of the medium, and an end of the first surface on a rear side from the first surface in the printing direction is a second end of the medium,
a first surface printing step of transporting the medium along a transport path by gripping the first end and printing a first image and a first test image in a single pass on the first surface of the medium using a printing unit provided on the transport path; and
a second surface printing step of transporting the medium along the transport path by gripping the second end after the first surface printing step and printing a second image and a second test image in a single pass on the second surface of the medium using the printing unit provided on the transport path,
wherein a gripping region is set at each of the first and second ends of the medium,
a region of the first surface excluding the gripping region is set as a first surface printable region, and a first image printing region for printing the first image and a first test image printing region for printing the first test image are set in the first surface printable region,
a region of the second surface excluding the gripping region is set as a second surface printable region, and a second image printing region for printing the second image and a second test image printing region for printing the second test image are set in the second surface printable region, and
the first and second test image printing regions are set in the same region of the first and second surfaces.

3. The double-sided printing method according to claim 1,
wherein a deformed region of the medium in case of transporting the medium by gripping the first end is set as a gripping region of the first end, and
a deformed region of the medium in case of transporting the medium by gripping the second end is set as a gripping region of the second end.

4. The double-sided printing method according to claim 1,
wherein the first test image printing region is set at an end of the first surface printable region on the first end side or on the second end side.

5. The double-sided printing method according to claim 1,
wherein, in case of printing the first and second images using ink of a plurality of colors, colors of ink to print the first test image and colors of ink to print the second test image are set so as to be switched for each medium, and the colors of ink to print the first test image and the colors of ink to print the second test image are set to different colors on the same medium.

6. The double-sided printing method according to claim 5,
wherein, in case black is included in the ink and a color of the first test image printed in the first test image printing region is set to black, a color of the second test image printed in the second test image printing region is set to black.

7. The double-sided printing method according to claim 5,
wherein, in case black is included in the ink and a color of the first test image printed in the first test image printing region is set to black, the second test image printing region is set to a blank.

8. The double-sided printing method according to claim 7,
wherein, in case a color of the second test image printed in the second test image printing region is set to black, the first test image printing region is set to a blank.

9. The double-sided printing method according to claim 1,
wherein, in case of printing the first and second images using ink of a plurality of colors, the first and second test images of the plurality of colors are disposed in the first and second test image printing regions, and colors of the first and second test images disposed in the same region are set to different colors.

10. The double-sided printing method according to claim 9,
wherein, in case black is included in the ink, a region where the first test image is printed and a region where the second test image is printed are set in the same region for the black.

11. The double-sided printing method according to claim 9,
wherein, in cases where black is included in the ink, a region of the second test image printing region corresponding to a region where the first test image of black is printed is set to a blank.

12. The double-sided printing method according to claim 11,
wherein a region of the first test image printing region corresponding to a region where the second test image of black is printed is set to a blank.

13. The double-sided printing method according to claim 1,
wherein a density of the first test image printed in the first test image printing region is set to be lower than a density of the second test image printed in the second test image printing region.

14. The double-sided printing method according to claim 13,
wherein, in case of printing the first and second test images in an ink jet method, the density of the first test image is set to be lower than the density of the second test image by changing a size of an ink droplet in case of printing the first test image and a size of an ink droplet in case of printing the second test image.

15. The double-sided printing method according to claim 1,
wherein, in case of printing the first and second test images in an ink jet method, each of the first and second test images is formed in a line pattern, and lines that form the first test image and lines that form the second test image are set so as not to overlap each other.

16. The double-sided printing method according to claim 1,
wherein, in case of printing the first and second test images in an ink jet method, each of the first and second test images is formed in a dot pattern, and dots that form the first test image and dots that form the second test image are set so as not to overlap each other.

17. The double-sided printing method according to claim 1,
wherein, in case of printing the first and second test images in an ink jet method, each of the first and second test images is formed in a patch pattern, and patches that form the first test image and patches that form the second test image are set so as not to overlap each other.

18. A double-sided printing apparatus that prints an image on first and second surfaces of a medium when one surface of the medium is the first surface and the other surface of the medium is the second surface, an end of the first surface on a front side from the first surface in a printing direction is a first end of the medium, and an end of the first surface on a rear side from the first surface in the printing direction is a second end of the medium, comprising:
a first transportation unit that transports the medium by gripping the first end of the medium;
a first printing unit that is provided on a transport path of the first transportation unit and prints a first image and a first test image in a single pass on the first surface of the medium transported by the first transportation unit;
a reversing unit that reverses the first and second surfaces of the medium;
a second transportation unit that transports the medium by gripping the second end of the medium reversed by the reversing unit;
a second printing unit that is provided on a transport path of the second transportation unit and prints a second image and a second test image in a single pass on the second surface of the medium transported by the second transportation unit; and
a print layout setting unit that sets a layout of the first image and the first test image to be printed on the first surface of the medium and a layout of the second image and the second test image to be printed on the second surface of the medium,
wherein the print layout setting unit sets a gripping region at each of the first and second ends of the medium gripped by the first and second transportation units, sets a region of the first surface excluding the gripping region as a first surface printable region and sets a first image printing region for printing the first image and a first test image printing region for printing the first test image in the first surface printable region, sets a region of the second surface excluding the gripping region as a second surface printable region and sets a second image printing region for printing the second image and a second test image printing region for printing the second test image in the second surface printable region, and sets the first and second test image printing regions in the same region of the first and second surfaces,
the first transportation unit transports the medium by adsorbing and holding the medium on a peripheral surface of a rotary drum or a rotary belt,
the second transportation unit transports the medium by adsorbing and holding the medium on a peripheral surface of a rotary drum or a rotary belt,
a first reading unit that is provided on the transport path of the first transportation unit and reads the first test image printed by the first printing unit, and a second reading unit that is provided on the transport path of the second transportation unit and reads the second test image printed by the second printing unit are further included, and
of a peripheral surface of a drum or a belt that forms the second transportation unit, a region in contact with the first test image printing region of the medium has a density equal to or greater than a highest density printable by the first printing unit.

19. A double-sided printing apparatus, comprising:
a transportation unit that transports a medium by gripping an end of the medium on a front side in a printing direction;
a printing unit that is provided on a transport path of the transportation unit and prints an image in a single pass on one surface of the medium transported by the transportation unit; and
a reverse transportation unit that receives, from the transportation unit, the medium having one surface on which the image is printed, reverses the medium, and feeds the medium to the transportation unit again,
wherein when one surface of the medium is a first surface and the other surface of the medium is a second surface, an end of the first surface on a front side from the first surface in a printing direction of the first surface is a first end of the medium, and an end of the first surface on a rear side from the first surface in the printing direction is a second end of the medium, a first image and a first test image are printed on the first surface of the medium in first printing and a second image and a second test image are printed on the second surface of the medium in second printing,
a print layout setting unit that sets a layout of the first image and the first test image to be printed on the first surface of the medium and a layout of the second image and the second test image to be printed on the second surface of the medium is provided,
the print layout setting unit sets a gripping region at each of the first and second ends of the medium gripped by the transportation unit, sets a region of the first surface excluding the gripping region as a first surface printable region and sets a first image printing region for printing the first image and a first test image printing region for printing the first test image in the first surface printable region, sets a region of the second surface excluding the gripping region as a second surface printable region and sets a second image printing region for printing the second image and a second test image printing region for printing the second test image in the second surface printable region, and sets the first and second test image printing regions in the same region of the first and second surfaces,
the transportation unit transports the medium by adsorbing and holding the medium on a peripheral surface of a rotary drum or a rotary belt,
a reading unit that is provided on the transport path of the transportation unit and reads an image printed on the medium is further included, and
of a peripheral surface of a drum or a belt that forms the transportation unit, a region in contact with the first test image printing region of the medium has a density equal to or greater than a highest density printable by the printing unit.

20. The double-sided printing apparatus according to claim 18,
wherein the print layout setting unit sets a deformed region of the medium in case of transporting the medium by gripping the first end as a gripping region of the first end, and sets a deformed region of the medium in case of transporting the medium by gripping the second end as a gripping region of the second end, and
the print layout setting unit sets the first test image printing region at an end of the first surface printable region on the first end side or on the second end side.
